(19) United States
(12) Patent Application Publication
(10) Pub. No.: US 2013/0093325 A1
(43) Pub. Date: Apr. 18, 2013

(54) LIGHT EMITTING DIODE (LED) LIGHTING SYSTEMS AND METHODS

(71) Applicant: Richard Scarpelli, Laguna Niguel, CA (US)

(72) Inventor: Richard Scarpelli, Laguna Niguel, CA (US)

(73) Assignee: Eco Lumens, LLC, Oceanside, CA (US)

(21) Appl. No.: 13/275,240

(22) Filed: Oct. 17, 2011

(51) Int. Cl. H05B 37/02

(52) U.S. Cl. 315/85

(57) ABSTRACT

Methods, systems, and devices for light emitting diode (LED) lighting, including a multi-channel LED driver circuit having an electromagnetic interference (EMI) filter and rectification circuit, a power factor correction (PFC) circuit, a current and voltage isolation circuit, a voltage control circuit, and a current control circuit; a wireless interface coupled between the EMI filter and rectification circuit and the PFC circuit; a heat sink including an intercooling and ventilation chamber for air or water cooling disposed therein; one or more screw mount LEDs electrically coupled to the LED driver circuit and thermally coupled to the heat sink; and a lens housing having one or more lenses integrally formed therein and removably coupled to the heat sink or screw mount LEDs and with the lenses disposed over the LEDs.

### CROSS REFERENCE TO RELATED DOCUMENTS

The present invention is related to commonly assigned, co-pending U.S. patent application Ser. No. 13/158,314 of Richard SCARPELLI, entitled “LIGHT EMITTING DIODE (LED) LIGHTING SYSTEMS AND METHODS,” filed on Jun. 10, 2011, which claims benefit of priority to U.S. Provisional Patent Application Ser. No. 61/353,643 of Richard SCARPELLI, entitled “LIGHT EMITTING DIODE (LED) LIGHTING SYSTEMS AND METHODS,” filed on Jun. 10, 2010, the entire disclosures of all of which are hereby incorporated by reference herein.

### BACKGROUND OF THE INVENTION

1. Field of the Invention

The present invention generally relates to systems and methods for providing lighting, and more particularly to improved light emitting diode (LED) lighting systems and methods.

2. Discussion of the Background

In recent years, 22% of all electrical energy is used for lighting. Of this electrical lighting energy, 42% is generated by incandescent bulbs, which represents about 9% of total electricity used. Accordingly, there is a need to develop systems and methods that provide better lighting, with greater efficiency, less heat and more brightness than conventional lighting, while at the same lowering the overall cost of electrical lighting use.

In addition, traditional lighting, for example, using incandescent and fluorescent lamps, produces a high volume of waste material. By 2017, it is expected that incandescent light bulb will be totally eliminated due to energy standards for energy conservation, and which could save up to $18 billion a year in usable electricity. Accordingly, such changes require new standards and the use of all available technology in next generation lighting systems.

Light emitting diodes (LEDs) have been around since about 1965. LED technology is opening doors for further technology progression in lighting systems. In addition, high power LEDs have been developed, but they are often more expensive than fluorescent, and high intensity discharge (HID) light sources. To justify such extra cost, LED lighting systems should produce more light from less electrical power, and should have a longer operating life.

All of the above indicates that there is a need for LED lighting systems and methods that are reliable, cost effective, and that provide improved performance, as compared to conventional lighting systems.

### SUMMARY OF THE INVENTION

Therefore, there is a need improved methods and systems for light emitting diode (LED) lighting that address the above and other problems with conventional lighting systems and methods. The above and other needs are addressed by the illustrative embodiments of the present invention, which provide an improved light emitting diode (LED), solid-state lighting (SSL) systems and methods. The systems and methods can include, for example, improved phase correction circuits, LED driver circuits, printed circuit boards (PCBs), heatsinks, LEDs, lens housings, endcaps, tombstones, adapter plates, brackets, fixtures, retrofit applications, lighting applications, and the like. Advantageously, the novel LED systems and methods can provide average energy savings in the 40% to 80% range, as compared to conventional lighting systems and methods. The novel systems and methods can include interchangeable LED subsystem components that provide high energy, high efficiency, high lumens, and lower heat dissipation, and that can be used in retrofit, as well as new lighting applications, as compared to conventional lighting systems and methods.

Accordingly, in illustrative aspects of the present invention, there are provided methods, systems, and devices for light emitting diode (LED) lighting, including a multi-channel LED driver circuit having an electromagnetic interference (EMI) filter and rectification circuit, a power factor correction (PFC) circuit, a current and voltage isolation circuit, a voltage control circuit, and a current control circuit; a wireless interface coupled between the EMI filter and rectification circuit and the PFC circuit; a heat sink including an intercooling and ventilation chamber for air or water cooling disposed therein; one or more screw mount LEDs electrically coupled to the LED driver circuit and thermally coupled to the heat sink; and a lens housing having one or more lenses integrally formed therein and removably coupled to the heat sink or screw mount LEDs and with the lenses disposed over the LEDs.

The methods, systems, and devices can include a phase correction circuit coupled to an input of the LED driver circuit.

The methods, systems, and devices can include a mounting bracket having clasps connected to ends of the heat sink.

The methods, systems, and devices can include a plurality of the LEDs are uniformly dispersed on the heatsink and optically aligned with a respective plurality of the lenses.

The methods, systems, and devices can include a plurality of the LEDs are uniformly dispersed, in series and optically aligned with a single respective lens disposed along a length of the lens housing.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIGS. 1A-1C show illustrative light emitting diode (LED) lighting systems and methods;

FIGS. 2A-2B show illustrative printed circuit boards (PCBs) that can be used in the illustrative LED lighting systems, methods and applications;

FIGS. 3A-3B show illustrative LED lens housings that can be used in the illustrative LED lighting systems, methods and applications;

FIGS. 4A-4B show illustrative heatsinks that can be used in the illustrative LED lighting systems, methods and applications;

FIG. 5 shows an illustrative endcap that can be used in the illustrative LED lighting systems, methods and applications;

FIG. 6 shows an illustrative tombstone that can be used in the illustrative LED lighting systems, methods and applications;

FIG. 7 shows an illustrative LED driver circuit that can be used in the illustrative LED lighting systems, methods and applications;

FIG. 8-9 show illustrative sub-circuits of the LED driver circuit of FIG. 7;

FIG. 10 shows an illustrative phase correction circuit of the illustrative LED lighting systems and methods;

FIG. 11 shows an illustrative e-coin LED that can be used in the illustrative LED lighting systems, methods and applications;

FIGS. 12-13 show illustrative retrofit applications for the illustrative LED lighting systems and methods;

FIG. 14A shows illustrative adapter plates that can be used with the illustrative LED lighting systems and methods;

FIG. 14B shows illustrative adapter plate applications for the adapter plates of FIG. 14A;

FIG. 15 shows illustrative brackets that can be used with the illustrative LED lighting systems and methods;

FIGS. 16A-16B show illustrative light fixtures that can be used with the illustrative LED lighting systems and methods;

FIGS. 17-20 are illustrative graphs, charts and visuals for illustrating the electrical performance of the illustrative LED lighting systems and methods;

FIGS. 21-22 are illustrative graphs, charts and visuals for illustrating the electrical performance of LEDs that can be used in the illustrative LED lighting systems, methods and applications;

FIG. 23 shows illustrative lighting applications for the illustrative LED lighting systems and methods;

FIG. 24 shows an illustrative e-coin LED that can be used in the illustrative LED lighting systems, methods and applications;

FIG. 25 shows an illustrative sport light fixture that can be used with the illustrative e-coin LEDs;

FIG. 26 shows a further illustrative LED lighting system and method;

FIG. 27 shows the illustrative heatsink of FIG. 14B(C) adapted for use with the illustrative e-coin LEDs;

FIG. 28 shows the illustrative e-coin LED of FIG. 24 in further detail and that can be used in the illustrative LED lighting systems, methods and applications;

FIG. 29 shows an illustrative can type LED lighting system of FIG. 14B(A) that can be used with the illustrative e-coin LEDs;

FIGS. 30-36 show further features and details of the illustrative sport light fixture of FIG. 25 that can be used with the illustrative e-coin LEDs;

FIGS. 37-41 show a further illustrative LED lighting system and method; and

FIGS. 42-49 show further illustrative drivers for the illustrative LED lighting systems and methods.

### DETAILED DESCRIPTION OF THE PREFERRED EMBODIMENTS

Improved methods, systems, and devices for light emitting diode (LED) lighting are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

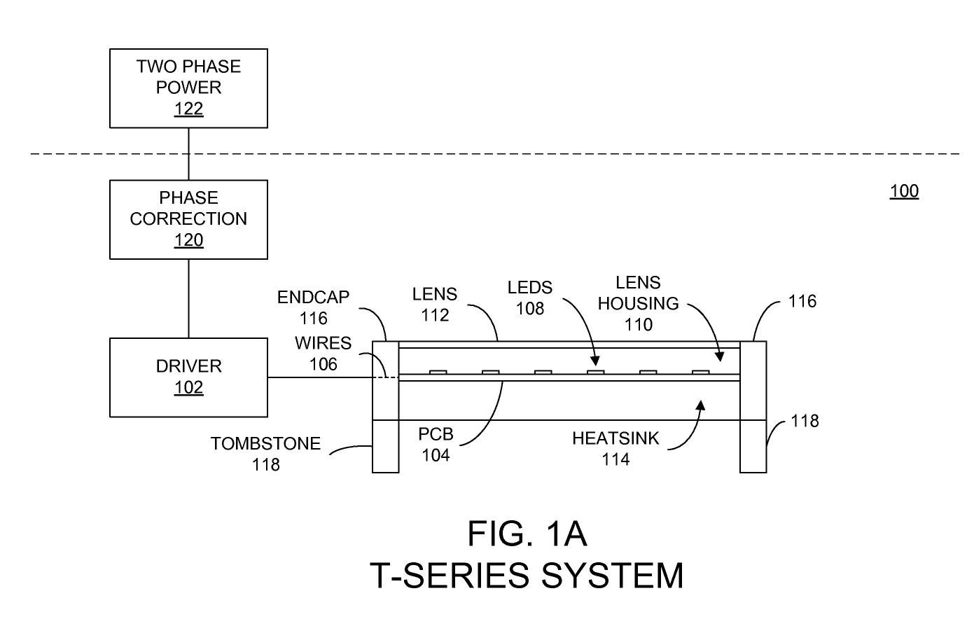

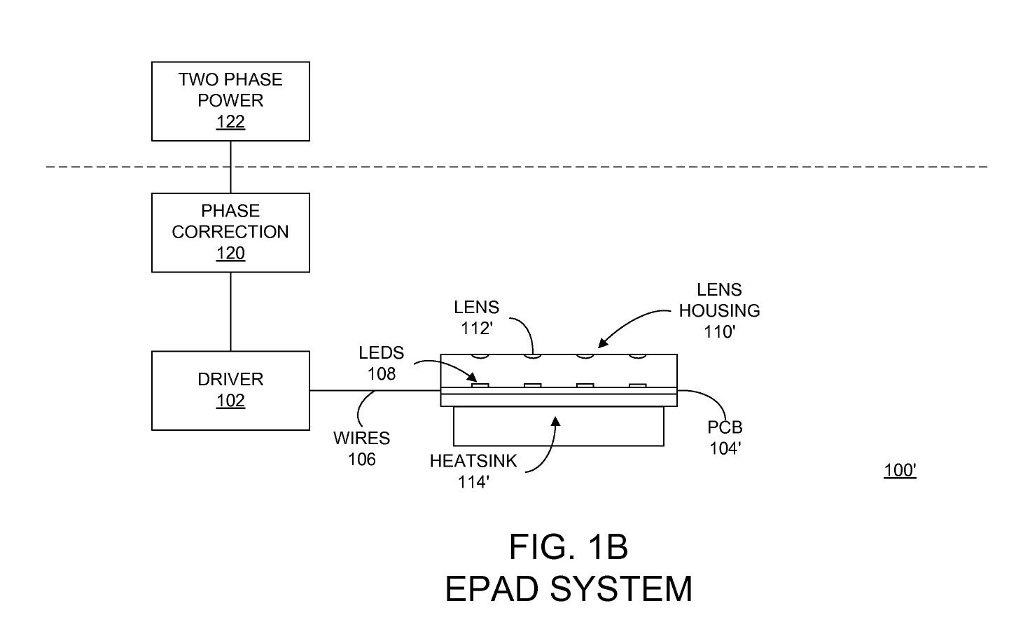

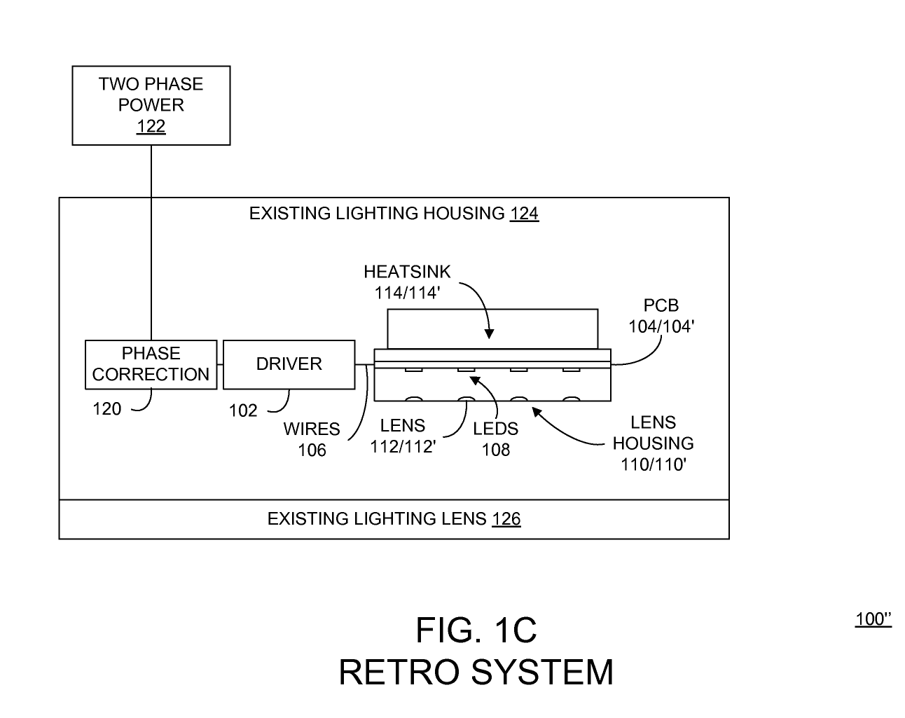

Referring now to the drawings, FIGS. 1A-1C thereof show illustrative light emitting diode (LED) lighting systems and methods, according to illustrative embodiments. In FIG. 1A, an illustrative LED lighting system and method 100 can receive power from a power source 122 (e.g., two-phase, 120 VAC, 240 VAC, etc.), and can include a phase correction circuit 120, an LED driver circuit 102, a printed circuit board (PCB) 104 coupled to the LED driver circuit 102 via wires 106, one or more LEDs 108 (e.g., a Samsung LED package, including 9 individual LED dies in one package), a lens housing 110 having one or more lenses 112, a heatsink 114, endcaps 116, and tombstones 118. Advantageously, the illustrative LED lighting system and method of FIG. 1A can be used with T-series lighting and retrofit applications (e.g., T5, T8 and T10 applications), and the like.

In FIG. 1B, an illustrative LED lighting system and method 100′ can receive power from the power source 122 (e.g., two-phase, 120 VAC, 240 VAC, etc.), and can include the phase correction circuit 120, the LED driver circuit 102, a printed circuit board (PCB) 104′ coupled to the LED driver circuit 102 via the wires 106, the one or more LEDs 108 (e.g., a Samsung LED package, including 9 individual LED dies in one package), a lens housing 110′ having one or more lenses 112′, and a heatsink 114′. Advantageously, the illustrative LED lighting system and method of FIG. 1B can be used with Hubbell-series lighting, Lithonia-series lighting, recessed, stage and custom design lighting and retrofit applications, and the like.

In FIG. 1C, an illustrative LED lighting system and method 100″ can receive power from the power source 122 (e.g., two-phase, 120 VAC, 240 VAC, etc.), and can include the phase correction circuit 120, the LED driver circuit 102, the printed circuit boards (PCBs) 104 or 104′ coupled to the LED driver circuit 102 via the wires 106, the one or more LEDs 108 (e.g., a Samsung LED package, including 9 individual LED dies in one package), the lens housing 100 or 110′ having the one or more lenses 112 or 112′, and the heatsink 114 or 114′, incorporated into an existing lighting housing 124 having an existing lighting lens 126. Advantageously, the illustrative LED lighting system and method of FIG. 1B can be used in retrofit applications for Hubbell-series lighting, Lithonia-series lighting, recessed and stage lighting, and the like.

In an illustrative embodiment, the illustrative LED lighting systems and methods can be configured so as to be rated as 12 V systems. For example, the LED driver circuit 102 can provide around 10 V up to around 12 V (or e.g., 10.9 V), direct current (DC) power to the PCBs 104 and 104′ via the wires 106. For example, the LEDs 108 can be configured to operate at around 180 milliamps at 12 V DC, as compared to conventional systems that operate at around 350 milliamps at 4 V DC. Advantageously, such a 12 V configuration allows for improved power factor correction, improved staging between the LEDs 108 and the AC power, improved AC to DC conversion, and the like, as compared to conventional systems and methods.

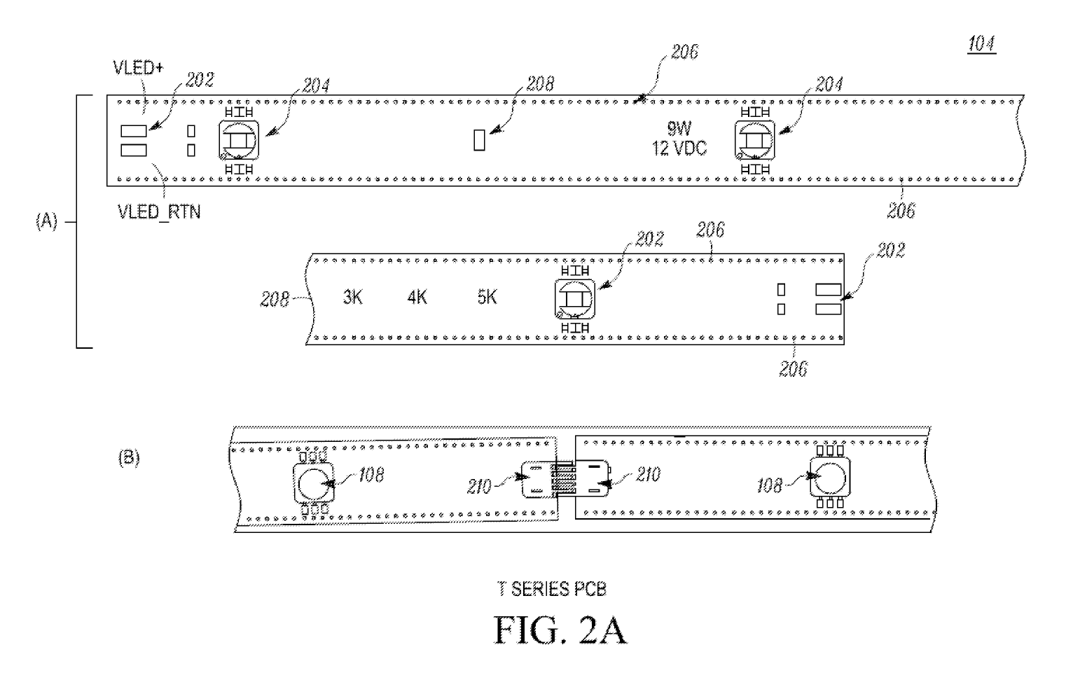

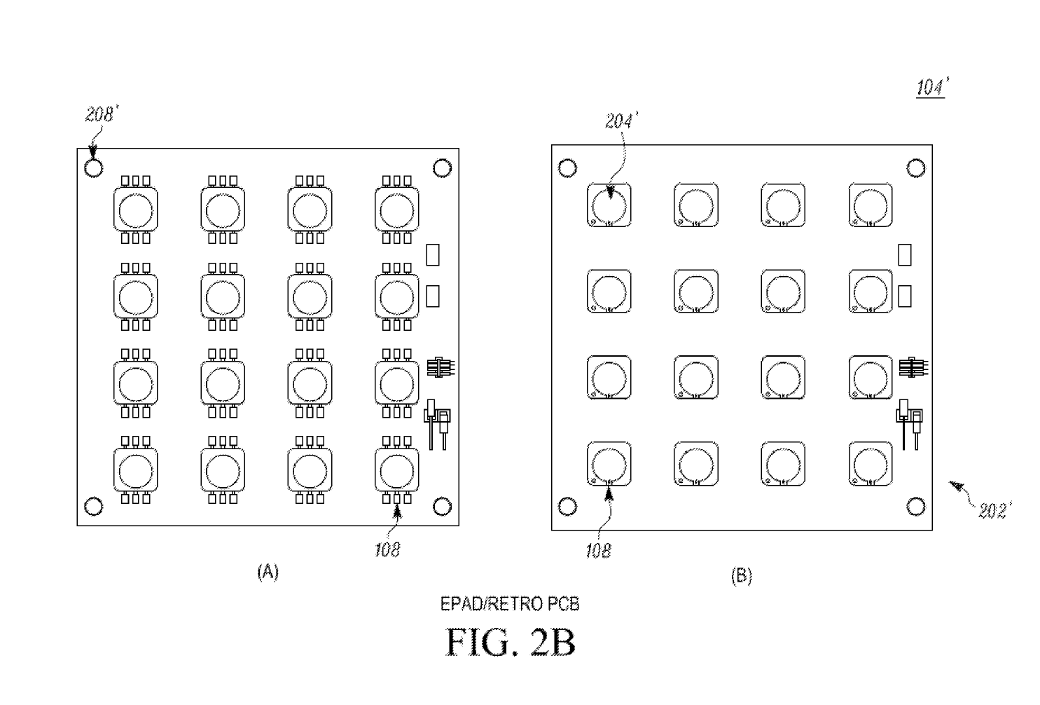

FIGS. 2A-2B show illustrative printed circuit boards (PCBs) that can be used in the illustrative LED lighting systems, methods and applications, according to illustrative embodiments. In FIG. 2A, the PCB 104 can accommodate one or more of the LEDs 108 via LED pads 204 (e.g., for a surface mount, solder connection). PCB pads 202 (e.g., for a solder connection) are provided for connecting the PCB 104 to the wires 106 and for connecting two or more of the PCBs 104 together in series via connectors 210. Heat expansion holes 206 as well as mounting holes 208 also are provided. In an illustrative embodiment, the PCB 104 can be configured with an exposed Gerber configuration on both sides of the PCB 104. Advantageously, the exposed Gerber configuration allows for a more reliable thermal contact between the PCB 104 and the heatsink 114 and the LEDs 108, allowing for faster thermal displacement between the LEDs 108 and the heatsink 114, and manufacturing cost savings. In further illustrative embodiments, however, conventional PCBs can be employed with an increase in manufacturing costs.

The illustrative LED lighting systems and methods include numerous advantages over conventional lighting systems and methods, including retrofitting into any suitable fixture, providing reliable connections and allowing for mounting directly to ceilings or walls via the endcaps 116 and the tombstones 118, and providing linear, solid state (LED) retrofit lighting lamp replacement (e.g., for T5, T8 and T10 applications) with an average savings of about >40% in energy over fluorescent tube lighting (FTL) based lighting. In addition, the illustrative LED lighting systems and methods can be serviced or repaired in the field, includes plug and play installation using the endcap 116 and the tombstone 118 adapters, avoids bad connections and can mount directly to a ceiling or wall, avoids shadow stacking and a need for recycling, is light control capable (e.g., light zone, motion and light sensor compatible), is dimmable with a silicon-controlled rectifier (SCR) type wall dimmer, provides an ideal optical system with optical power correction lens conservation of radiance (e.g., electromagnetic radiation), increases footprint and LUX output, with 5 or 8 LEDs produces 250 lm @ 250 mA, has a high luminous efficiency, has a power factor of about 0.99 with THD of about <10%, can accept an input voltage of about 90V˜305 VAC, 50˜60 Hz, 300 mA-150 mA, and 480V and 600 VAC/24 VDC, has a CCT color temperatures of about of about 3000, 4000 and 5000 Kelvin, has a high color rendering index (CRI) of about 81, provides total lumens at a 4 ft high output at about 3040 lm @ 30 W, 1900 lm @ 18 W and at a 2 ft high output at about 1520 lm @ 14 W, 950 lm @ 9 W, operates in high humidity, has an instant start, is solar photovoltaic (PV) panel and wind turbine compatible, has beam angle base on fixture being retro, and has about a 50,000 hour lifespan on a solid state (LED) light source.

In FIG. 2B, the PCB 104′ can accommodate one or more of the LEDs 108 via LED pads 204′ (e.g., for a surface mount, solder connection). Universal power pads 202′ are provided for connecting the PCB 104′ to the wires 106 with various wiring configurations (e.g., for a solder connection, a Molex connection, a wiper blade connection, etc.). In an illustrative embodiment, the PCB 104′ can be configured as a metal core board, as compared to an exposed Gerber configuration. Advantageously, the metal core board configuration allows for proper heat dissipation between the PCB 104′ and the heatsink 114′ and the LEDs 108. In further illustrative embodiments, however, PCBs with an exposed Gerber configuration can be employed with accommodation for any increased heat dissipation.

The LED lighting system and method of FIGS. 1B-1C include numerous advantages over conventional lighting systems and methods, including providing an average energy savings of about >70% over incandescent, fluorescent or high intensity discharge (HID) lamps (e.g., mercury vapor, high pressure sodium, arc metal halide, pulse start metal halide, metal halide, etc.). In addition, the LED lighting system and method of FIGS. 1B-1C include the ability to be serviced or replaced in the field, high luminous efficiency, polarization-matched LEDs, CCT color temperatures of about 3000, 4000 and 5000 Kelvin, a high color rendering index (CRI) of about 81, a luminous flux for the LEDs of about 250 lm @ 250 mA Luminous Flux (1 W) (e.g., about 100 lm/W (@120 mA), electrical properties: Reverse Voltage VR IF=5 mA-−16.5 V Forward Voltage VF IF=250 mA S0 S1 8.9-10.0V), and a single sided MCPCB material (e.g., about 1 oz Copper/0.062 6061T6 ALUM ALLOY 1 MASK, WHITE, SILK GREEN, IMM AU, HI-POT TEST AT 1000 VDC FOR 3 SECOND).

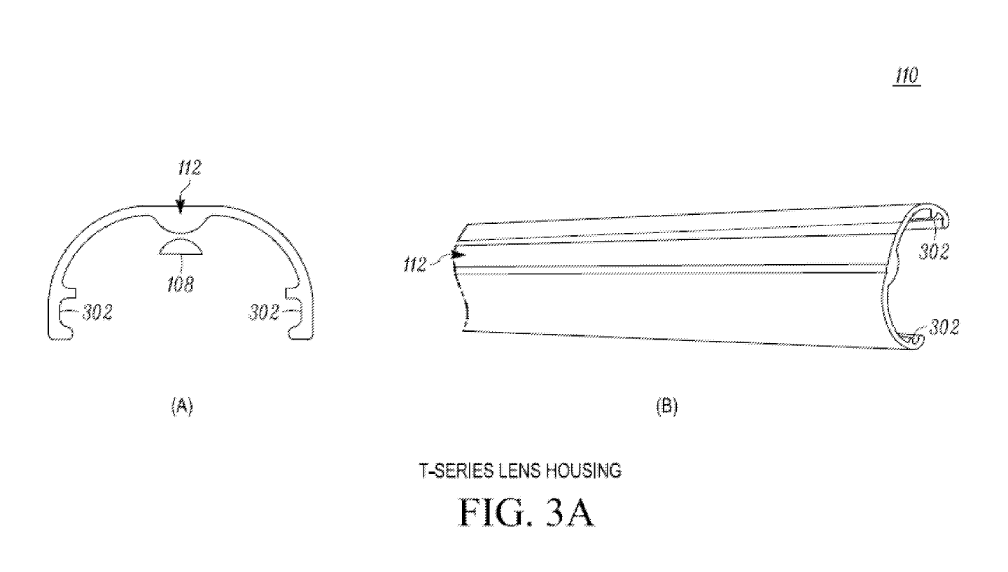

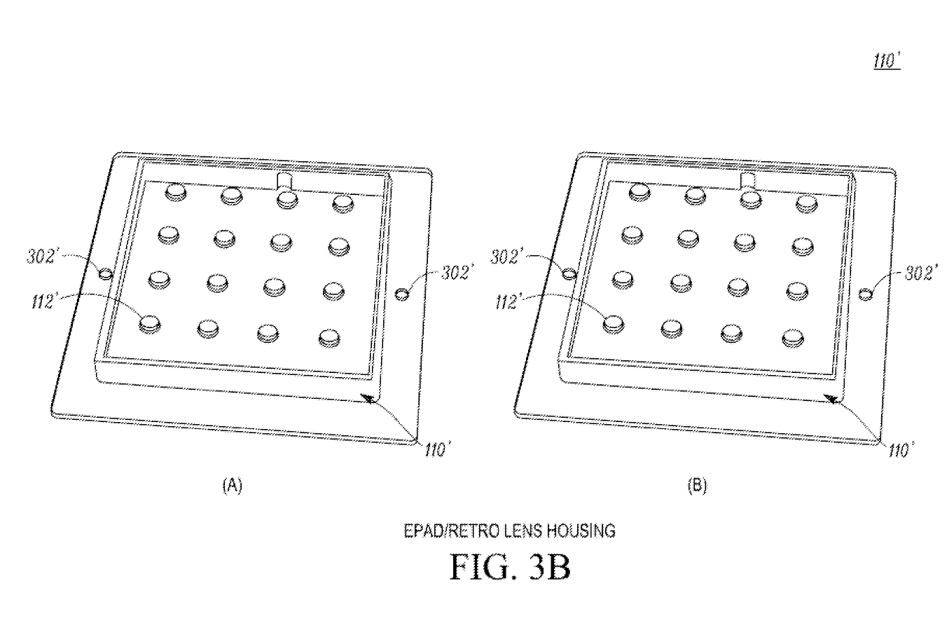

FIGS. 3A-3B show illustrative LED lens housings that can be used in the illustrative LED lighting systems, methods and applications, according to illustrative embodiments. In FIG. 3A, the LED lens housing 110 (e.g., made from a plastic material) can include the LED lens 112 integral with and disposed along the entire length of the LED lens housing 110 and configured to optically align with the LEDs 108 of the PCB 104. Rails 302 are provided for slidably mounting the LED lens housing 110 with the heatsink 114, advantageously, resulting in ease of assembly, disassembly, and maintenance.

In FIG. 3B, the LED lens housing 110′ (e.g., made from a plastic material) can include one or more of the LED lenses 112′ integral with and uniformly disposed throughout the LED lens housing 110′ and configured to optically align with the LEDs 108 of the PCB 104′. Mounting holes 302′ are provided for fixedly mounting the LED lens housing 110′ with the heatsink 114′, advantageously, resulting in ease of assembly, disassembly, and maintenance.

Advantageously, the lenses 112 and 112′ provide for light magnification and spreading functions, which can be modified based on the geometrical configurations of the lenses 112 and 112′. In addition, the lenses 112 and 112′ can be made of various colors (e.g., red, blue, green, yellow, etc.), provide an ideal optical system, provide optical power correction, provide conservation of radiance (e.g., electromagnetic radiation), and provide an increased emitted light footprint and LUX output, so as to accommodate a wide variety of lighting applications.

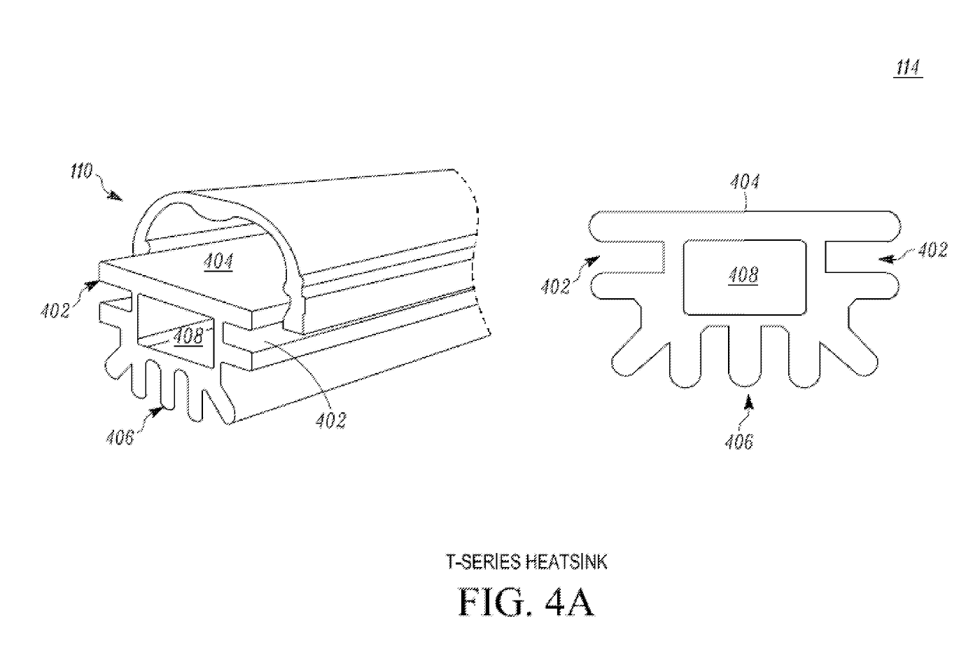

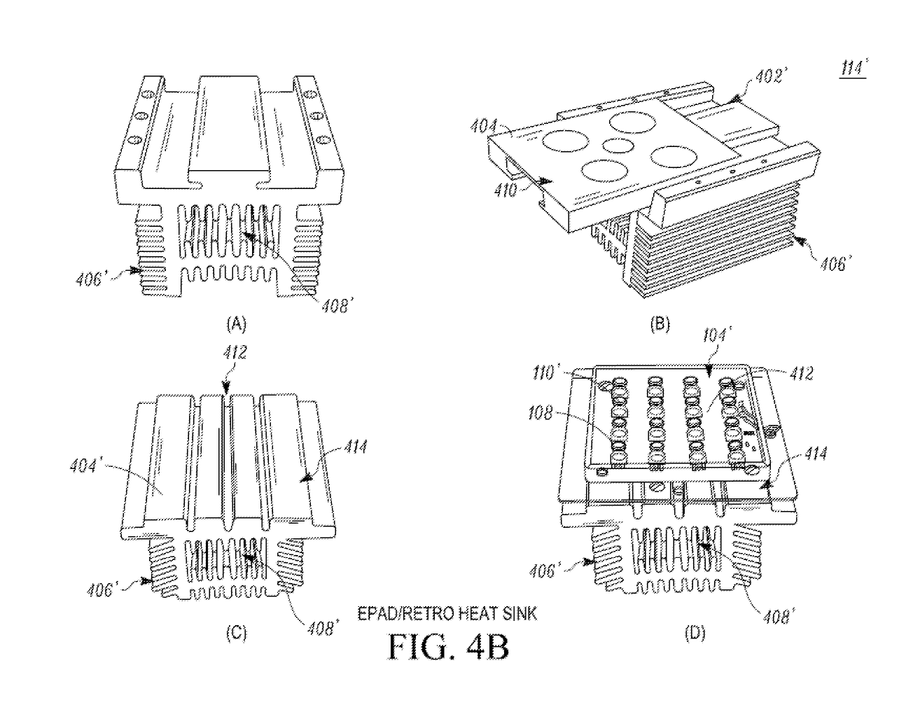

FIGS. 4A-4B show illustrative heatsinks that can be used in the illustrative LED lighting systems, methods and applications, according to illustrative embodiments. In FIG. 4A, the heatsink 114 (e.g., made of aluminum) can include rails 402 for slidably mounting with the LED lens housing 110, a PCB plane 404 for thermally coupling to and mounting of the PCB 104, and cooling fins 406 and mounting/ventilation hole/intercooling chamber 408 (e.g., configured for liquid and/or air cooling) for improved thermal dissipation.

In FIG. 4B, as shown in (A) and (B), a two-piece heatsink 114′ (e.g., made of aluminum) can include slide rails 402′ for slidably mounting with a heat plate 410, which attaches to the LED lens housing 110′, and includes a PCB plane 404′ for thermally coupling to and mounting of the PCB 104′, and cooling fins 406′ and ventilation hole/intercooling chamber 408′ (e.g., configured for liquid and/or air cooling) for improved thermal dissipation. As shown in (C) and (D), a one-piece heatsink 114′ further includes cooling channels 412 and cooling decks 414 that align with the rows of LEDs 108 on PCB 104′ for improved thermal dissipation and cooling.

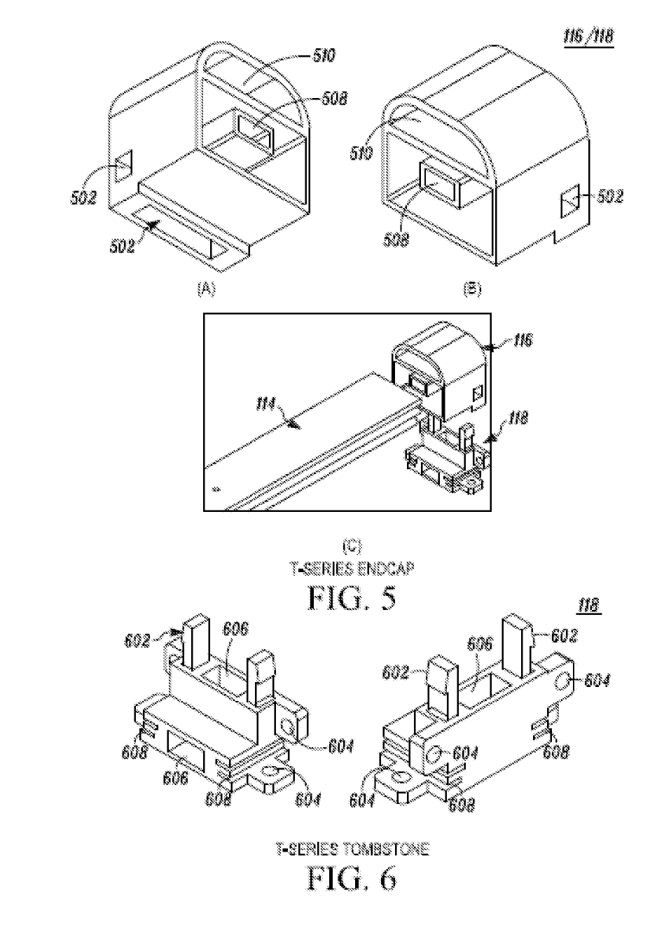

FIG. 5 shows an illustrative endcap that can be used in the illustrative LED lighting systems, methods and applications. FIG. 6 shows an illustrative tombstone that can be used in the illustrative LED lighting systems, methods and applications. In FIGS. 5-6, the tombstones 118 can be removably fixed onto a lighting housing fixture via the mounting hole 604. The endcaps 116 snap into place over the tombstones 118 via connectors 602 and corresponding mounting holes 502. The heatsink 114 slidably mounts into the endcaps 116 via mounting holes and slots 508. Similarly, the lens housing 110 slidably mounts into the endcaps 116 via the lens housing slots 510. A wiring pathway is provided via slots 606 on the tombstones 118 and the corresponding slots 510 of the endcaps 116. In this way, the wiring path from slot 510 continues through to the back wall of the endcap 116 and goes down 90 degrees and goes out the bottom through the slot 502 of the endcap 116 into the corresponding slot 606 of the tombstone 118. The tombstones 118 also can include linear mounting slots 608 for mounting onto conventional light fixtures. Advantageously, with the mounting holes 604 and the snap-in features of the endcaps 116 and the tombstones 118, various vertical or horizontal mounting options are provided.

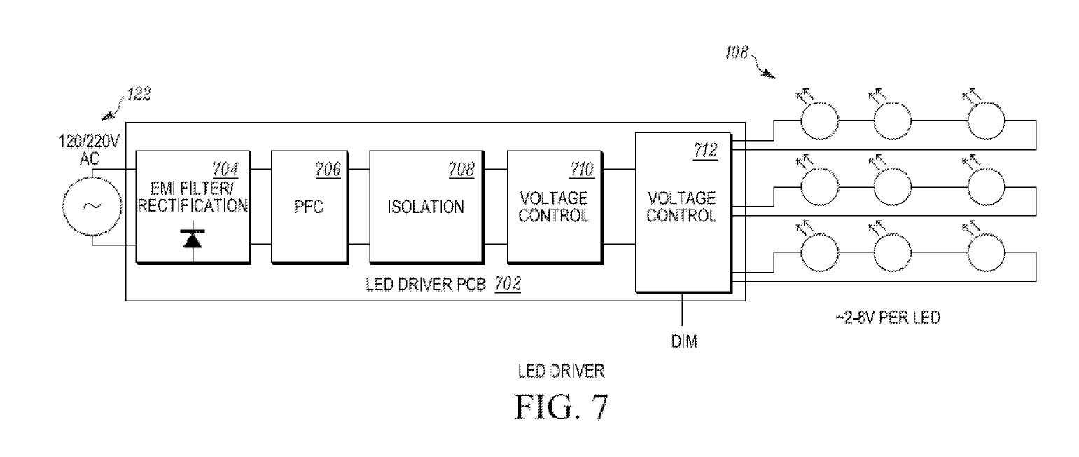

FIG. 7 shows an illustrative LED driver circuit that can be used in the illustrative LED lighting systems, methods and applications. In FIG. 7, the LED driver circuit 102 receives power from the power source 122 and is mounted on a printed circuit board 702 and can include electromagnetic interference (EMI) filter/rectification circuit 704, power factor correction (PFC) circuit 706, current/voltage isolation circuit 708, voltage control circuit 710, and current control circuit 712. Although the LED driver circuit 102 of FIG. 7 is shown as driving three channels or banks of LEDs 108, advantageously, the LED driver circuit 102 can be configured from one to as many channels as are needed by appropriate scaling of the circuits 704-712. A dimming function (DIM) can be provided on the current control circuit 712, as shown in FIG. 7.

The LED driver circuit 102 includes numerous advantages over conventional LED driver circuits, including a wide input voltage range with high power factor (PF) and low total harmonic distortion (THD), efficiency that can be optimized with greater efficiency at higher power, dimming capabilities with various sources (e.g., phase cut, 0-10V, DALI, etc.), light control capabilities (e.g., light zone, motion and light sensor compatible, etc.), being dimmable with a typical silicon-controlled rectifier (SCR) type wall dimmer, providing multiple regulated outputs, capabilities for use in more expensive, high end applications with power above 50 W, an input voltage of about 90V˜305 VAC, 50˜60 Hz, 300 mA-150 mA, 480V and 600 VAC/24 VDC, ADVANCED PFC+BALLAST CONTROL IC, critical-conduction mode boost-type power factor correction (PFC), Power Factor Correction (PFC) with Power Factor of about 0.99 with total harmonic distortion (THD) of about <10%, compliance with IEC 60384-14, 3rd edition, isolation with step down, PFC over-current protection, half-bridge over-current protection, preheat frequency, preheat time, closed-loop ignition current regulation, closed-loop ignition regulation for reliable lamp ignition, ultra low THD, lamp removal/auto-restart function, front end circuit LED driver based on IR HVIC combo chip (e.g., PFC+High/Low side driver), current regulation with an LED Buck Regulator Control IC, output voltages of about 30 W @ 24 VDC, output operating frequency of about >=120 Hz, and synchronous rectification for increased efficiency in high output current applications (e.g., for 1.5 A LED panels with diode drop: 1.5 A×1V=1.5 W (+switching losses), synchronous rectification: 25 mOhm×1.5 A×1.5 A=0.06 W*Temperature difference on components >30 degrees C.).

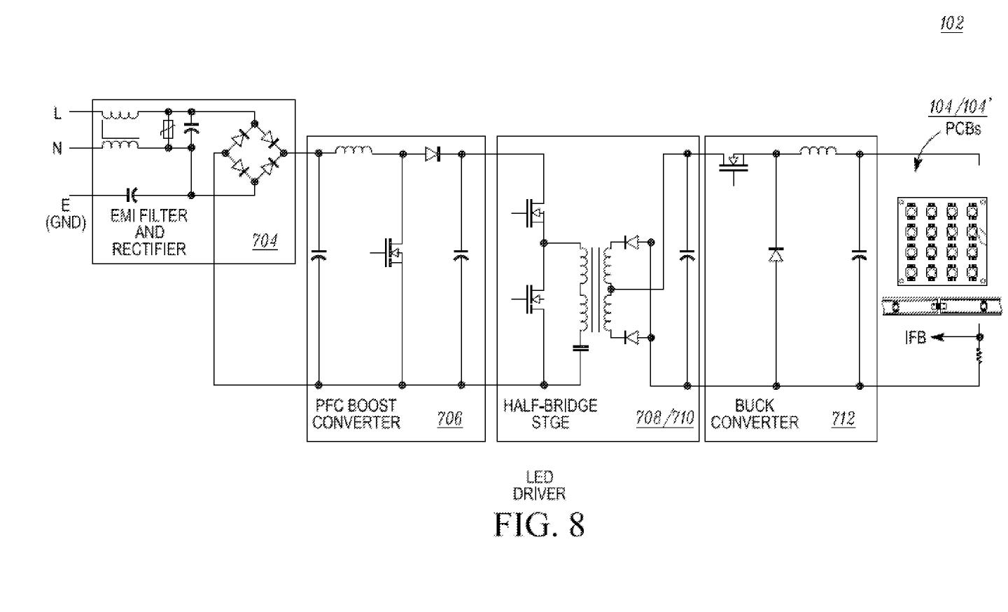

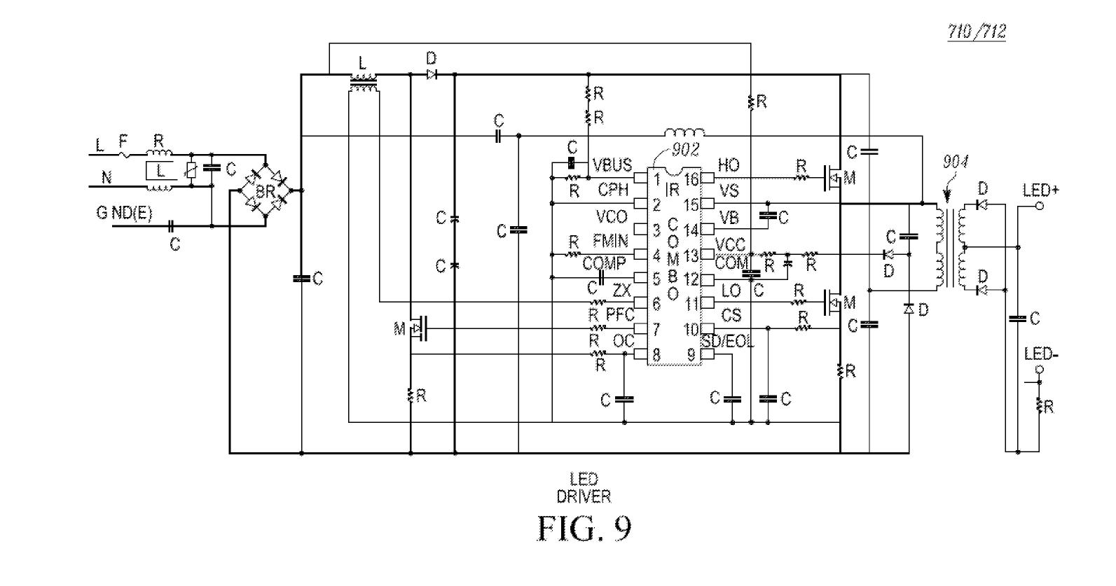

FIG. 8-9 show illustrative sub-circuits of the LED driver circuit of FIG. 7, according to illustrative embodiments. In FIG. 8, the main stages inside the LED driver circuit 102 are shown, including a PFC boost converter stage 706 at the front end coupled to the EMI filter/rectification circuit 704, followed by a half bridge switcher and a step down transformer stage 708/710, and a final back end stage 712, including a constant current Buck regulator with inherent short circuit protection coupled to the PCBs 104 or 104′. In FIG. 9, circuits 710/712 of the LED driver circuit 102 are shown, including an infrared (IR) combo LED driver integrates circuit (IC) 902 with power factor correction and half bridge control. The IC 902 maintains a regulated high voltage bus and drives a primary of a step down transformer 904, while also providing a power factor above 0.9 at the AC input with low total harmonic distortion (THD).

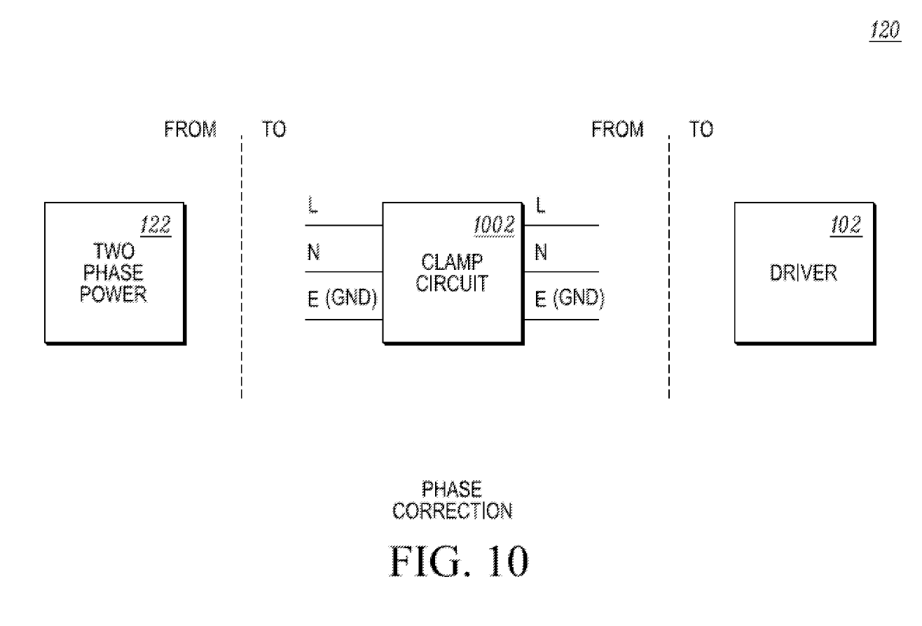

FIG. 10 shows an illustrative phase correction circuit of the illustrative LED lighting systems and methods. In FIG. 10, the phase correction circuit 120 is configured as a clamp circuit 1002 provided between the two phase power 122 and the LED driver circuit 102. Advantageously, the clamp circuit 1002 can be used to solve the problem of unbalanced neutrals when implementing A/B switching (e.g., for implementing Title 24 Energy Efficiency Standards). The clamp circuits 1002 can include one or more capacitors, zener diodes, and the like, configured to clamp any high voltage/current spikes due to unbalanced neutrals during A/B switching. The zener diodes can clamp down the high voltage/current spikes, with the capacitors being charged and then slowly discharged. The clamp circuit design of FIG. 10 is advantageous over designs using varistors and/or power cycle based designs.

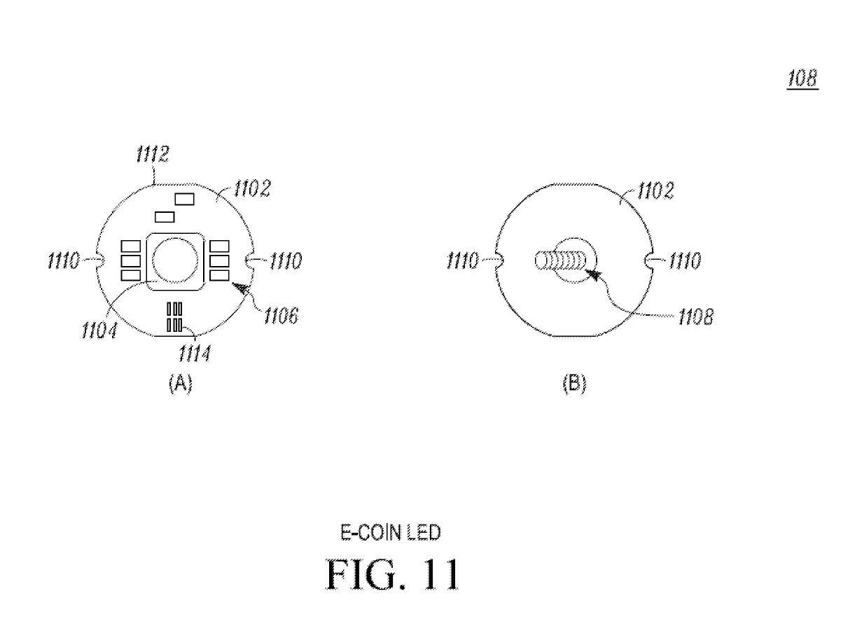

FIG. 11 shows an illustrative e-coin LED that can be used in the illustrative LED lighting systems, methods and applications. In FIG. 11, an e-coin LED 108 can include a single LED package 1104 (e.g., a Samsung LED package, including 9 individual LED dies in one package) mounted on a metal disk heat sink/base 1102 having a fastener 1108 (e.g., a screw type fastener) and mounting slots 1110 (e.g., for pneumatic assembly). The e-coin LED 108 further includes LED pads 1106 for mounting of the LEDs 1104 (e.g., for surface mount, solder mounting), two-wire wiring pads 1112 (e.g., for solder wiring), and wireless wiring pads 1114 (e.g., for solderless wiring using corresponding wiper blades, not shown). Advantageously, with this design, when the e-coin 108 is screwed down in place, the stud 1108 provides for ground continuity and the wipers blades from above (not shown) mate up with the wireless mounting pads 1114 to form an electrical connection.

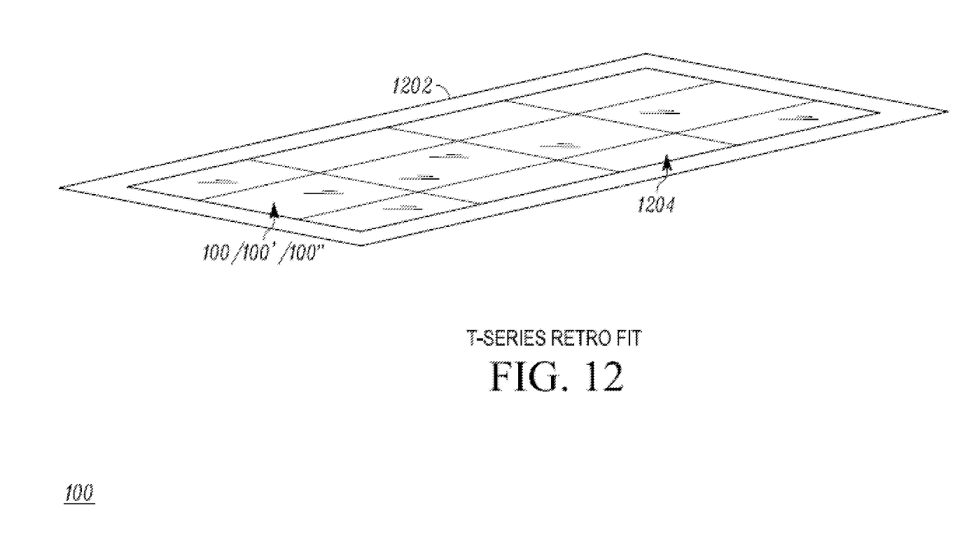

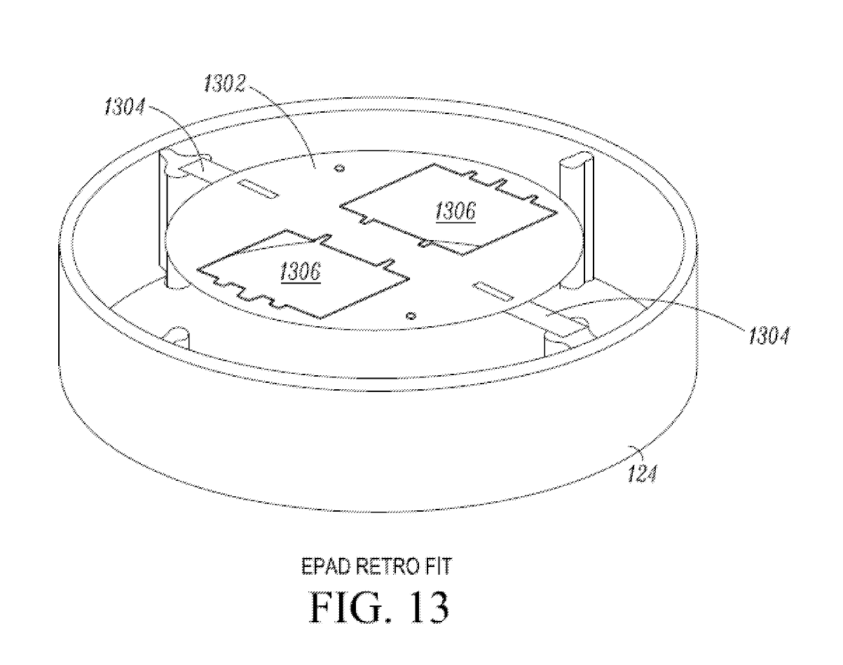

FIGS. 12-13 show illustrative retrofit applications for the illustrative LED lighting systems and methods, according to illustrative embodiments. In FIG. 12, the LED lighting systems and methods 100-100″ of FIGS. 1A-1C can be incorporated into existing lighting 1202 and employ the existing lighting lenses 1204. In FIG. 13, the LED lighting systems 100′-100″ of FIGS. 1B-1C can be incorporated into the existing lighting housing 124 via brackets 1304 and an adapter plate 1302. Advantageously, one or more openings 1306 can be provided in the adapter plate 1302 to accommodate one or more of the PCBs 104 or 104′ of the lighting systems 100′-100″ of FIGS. 1B-1C.

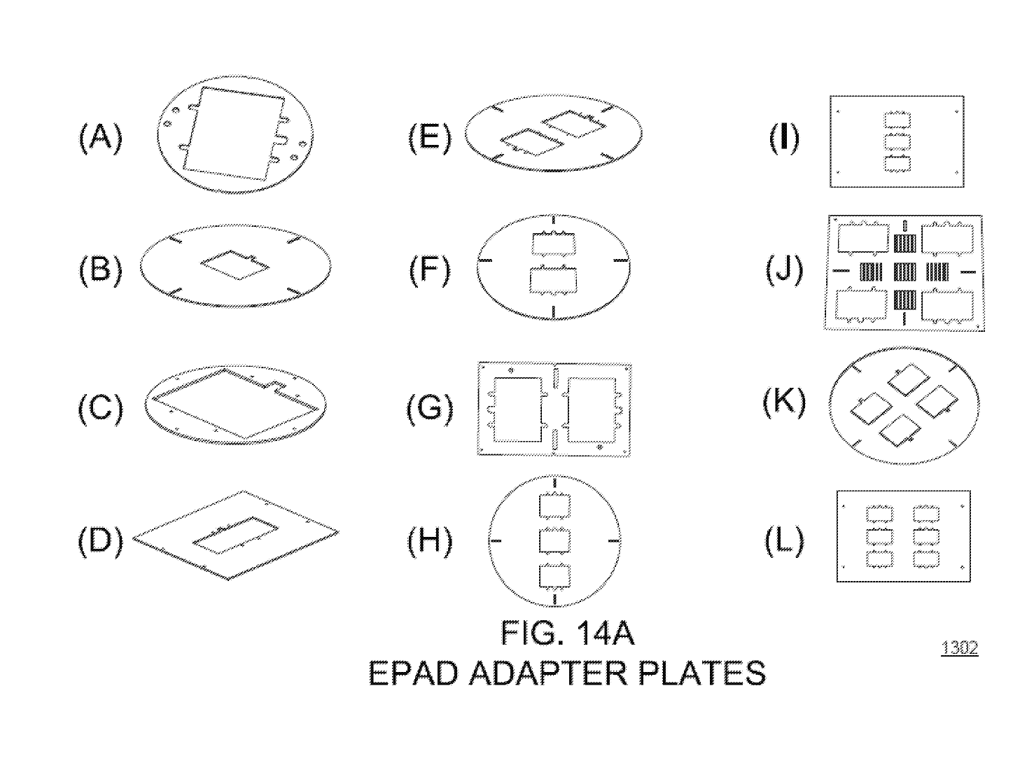

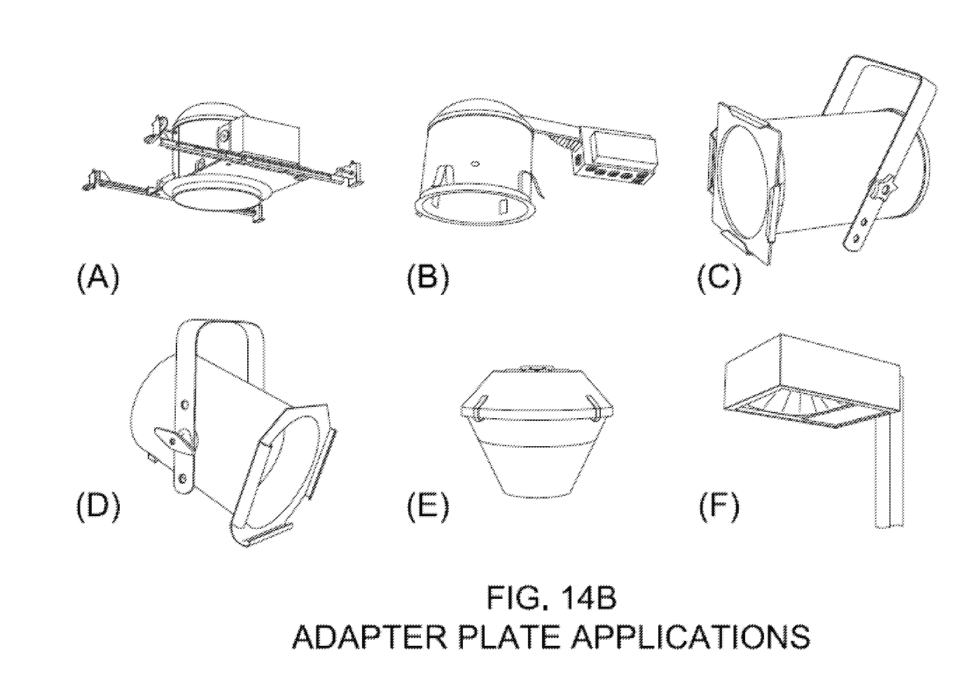

FIG. 14A shows illustrative adapter plates that can be used with the illustrative LED lighting systems and methods, according to illustrative embodiments. In FIG. 14A, advantageously, the adapter plates 1302 can be configured with any suitable combination of patterns, holes and slots, as shown in (A)-(L), for accommodating one or more of the PCBs 104 or 104′ of the lighting systems 100′-100″ of FIGS. 1B-1C.

FIG. 14B shows illustrative adapter plate applications for the adapter plates of FIG. 14A, according to illustrative embodiments. In FIG. 14 B, the adapter plates can be used in wall mount applications, ceiling mount applications, stage lighting applications, recessed lighting applications, Hubble lighting applications, Lithonia lighting applications, and the like, as shown in (A)-(F).

The LED systems of FIG. 14B when used for roadway lighting systems (e.g., cobra head lighting systems as shown in FIG. 14B(F), etc.) can provide energy savings over convention HID cobra head lighting systems, for example, as shown in Table 1 below.

TABLE 1
Typical energy savings over convention HID cobra head lighting systems

| | Eco Lumens Roadway | Energy |
|---|---|---|
| Typical Cobra Head HID | Wattage | Saving |
| 70 HP5 | 32 | 63% |
| 100 HP5 | 32 | 73% |
| 150 HP5 | 54 | 64% |
| 250 HP5 | 64 | 79% |
| 400 HP5 | 96 | 79% |
| 1000 HP5 | 128 | 89% |
| 70 MH | 32 | 63% |
| 100 MH | 32 | 73% |
| 150 MH | 64 | 64% |
| 250 MH | 64 | 79% |
| 400 MH | 96 | 79% |
| 1000 MH | 128 | 89% |

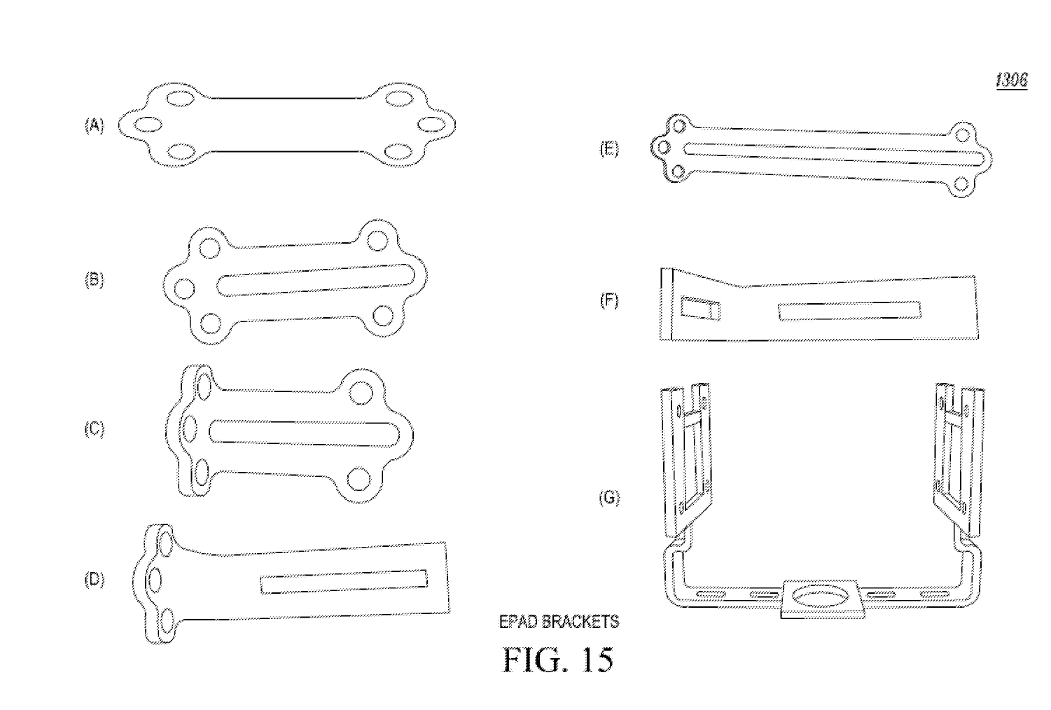

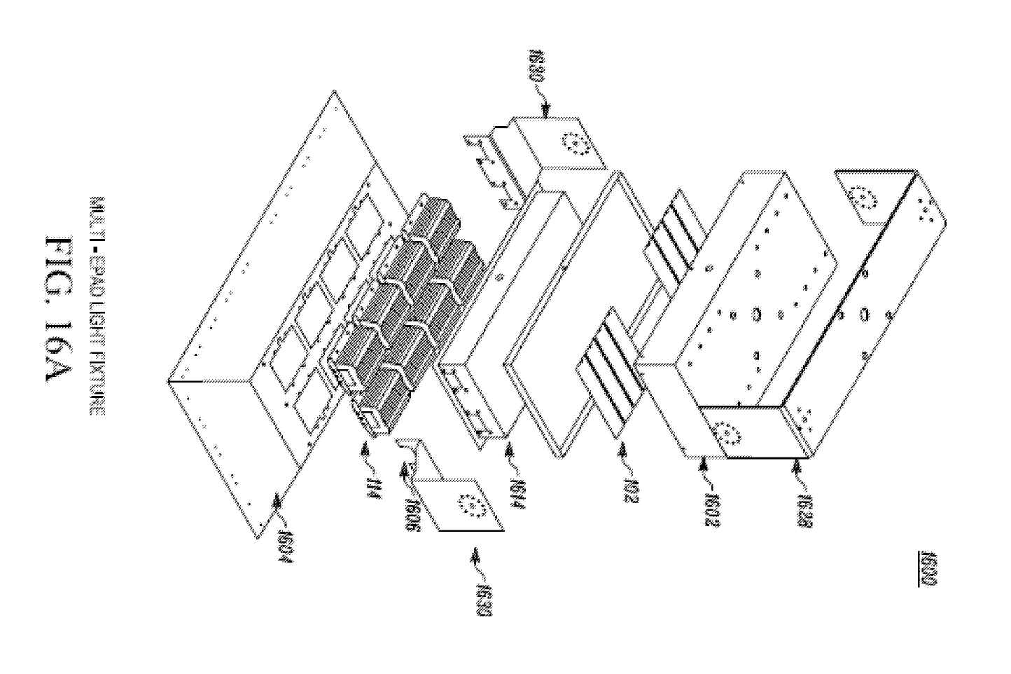

FIG. 15 shows illustrative brackets that can be used with the illustrative LED lighting systems and methods, according to illustrative embodiments. In FIG. 15, the brackets 1304 can be configured in a variety of configurations, as shown in (A)-(G), for accommodating the various applications described with respect to FIGS. 14A-14B.

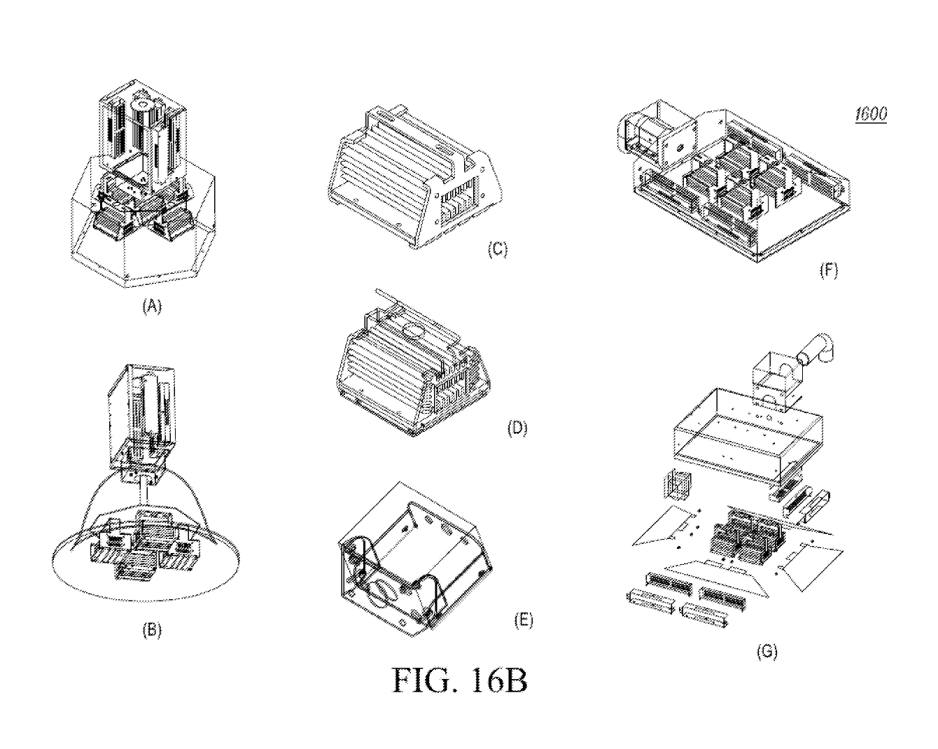

FIGS. 16A-16B show illustrative light fixtures that can be used with the illustrative LED lighting systems and methods, according to illustrative embodiments. In FIG. 16A, a light fixture 1600 can include a housing 1602 for accommodating one or more of the LED drivers 102, a mounting bracket 1628, a housing 1614 for accommodating one or more of the heatsinks 114′ corresponding to the LED drivers 102, brackets 1630 including cooling chamber windows 1606 corresponding to the intercooling chambers 408′ of the heatsinks 114′, and a reflector housing 1604 for accommodating one or more of the PCBs 104′. In FIG. 16B, advantageously, the light fixture 1600 can be configured in a variety of configurations, as shown in (A)-(G).

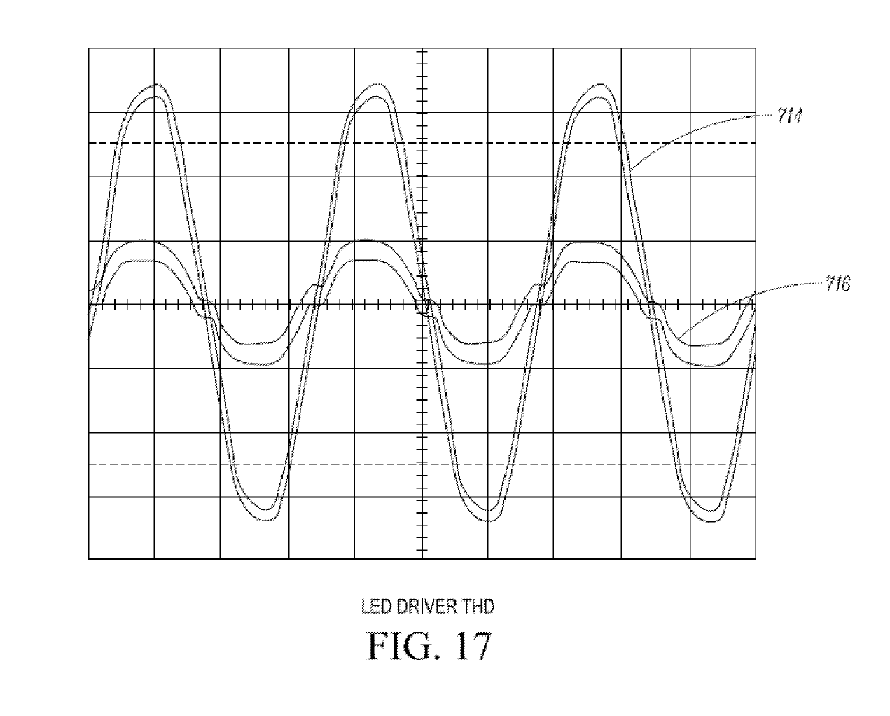

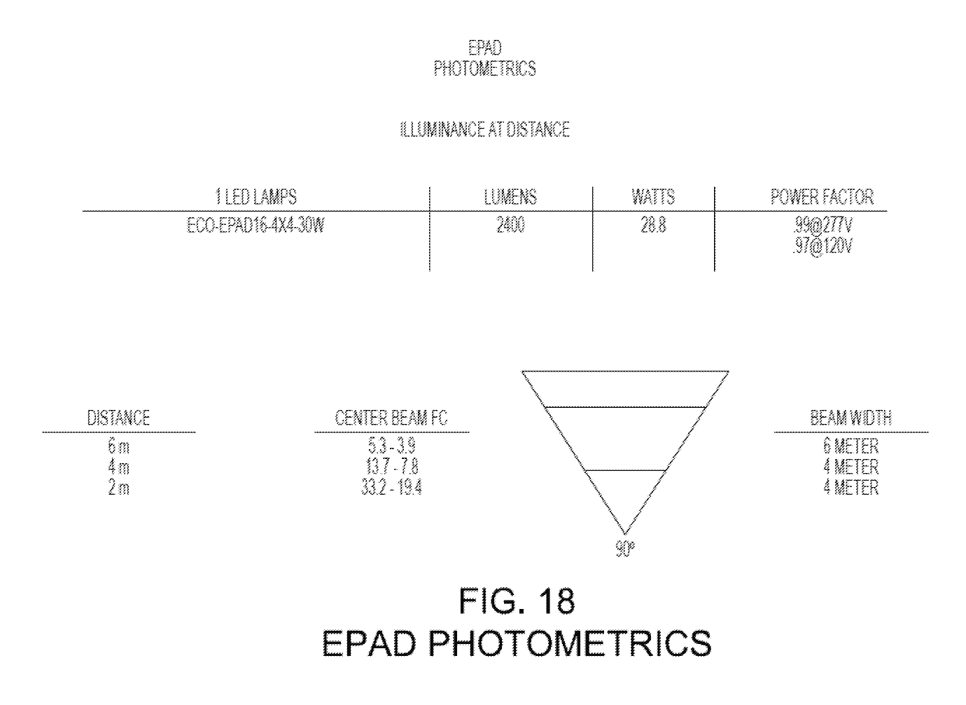

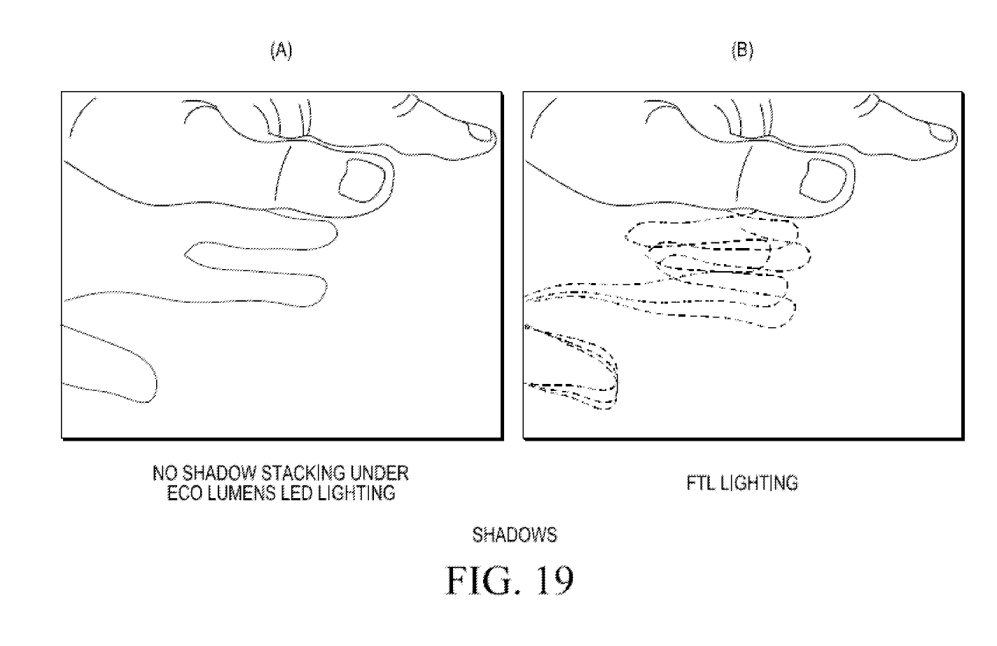

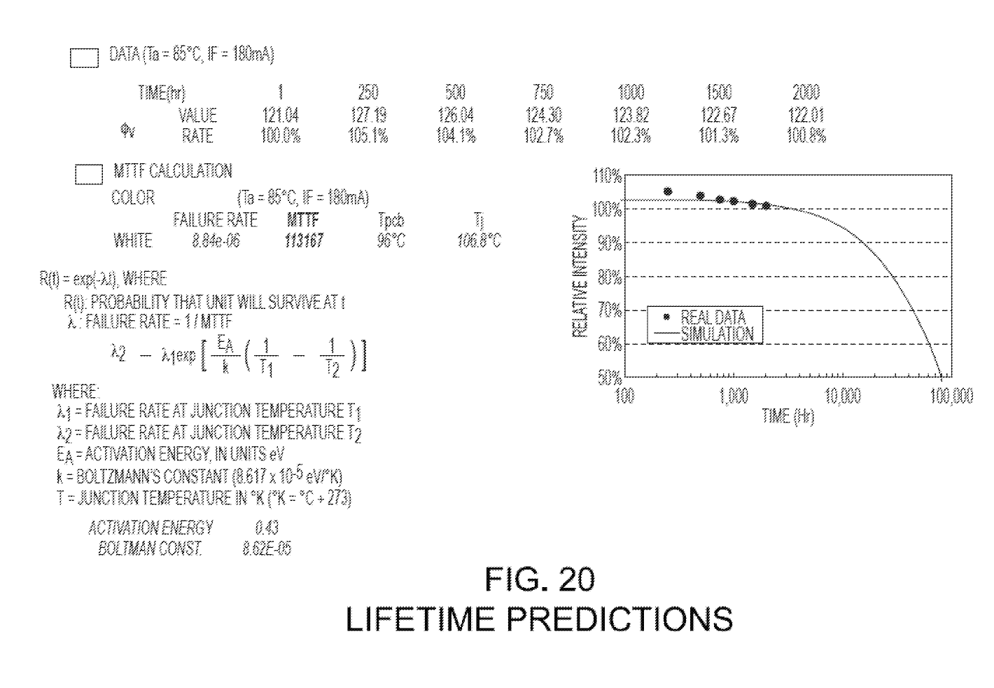

FIGS. 17-20 are illustrative graphs, charts and visuals for illustrating the electrical performance of the illustrative LED lighting systems and methods, according to illustrative embodiments. In FIG. 17, the performance of the LED driver circuit 102, including a full wave rectifier with power factor correction (PFC), is graphically shown, wherein the power factor is about 0.99 with a total harmonic distortion (THD) of less than about 10%, as can be measured from line input voltage trace 714 and line current trace 716. In FIG. 18, illustrative photometric measurements, including beam width measurements, are shown. In FIG. 19, as shown in (A), no shadow stacking occurs with the illustrative LED lighting systems and methods, as compared to conventional systems and methods (e.g., fluorescent tube lighting (FTL)), as shown in (B). In FIG. 20, illustrative lifetime predictions and corresponding measurements for the illustrative LED lighting systems and methods are shown.

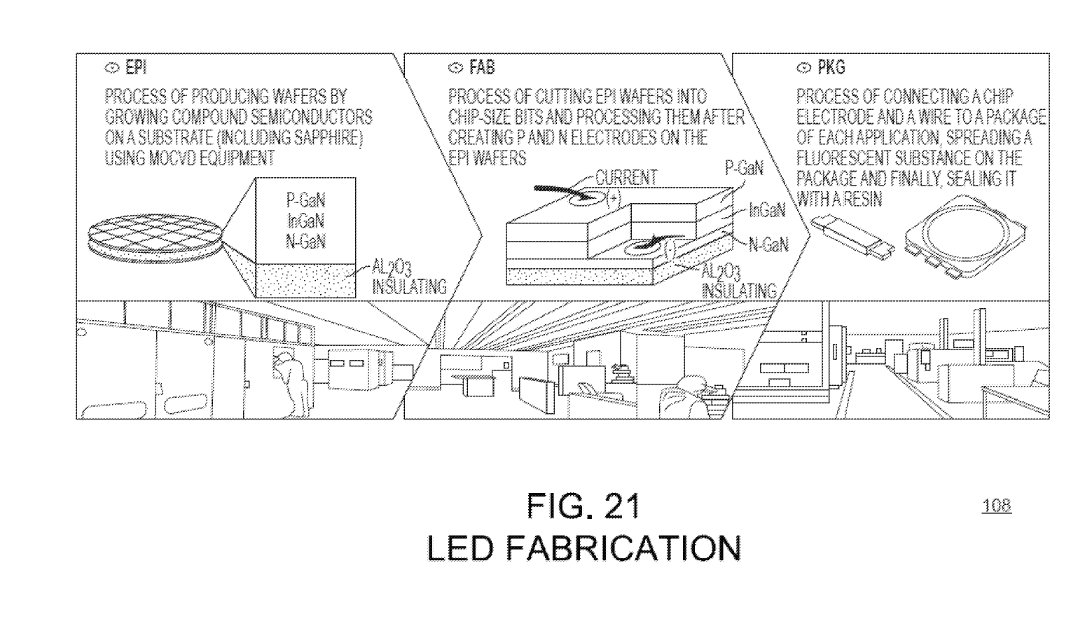

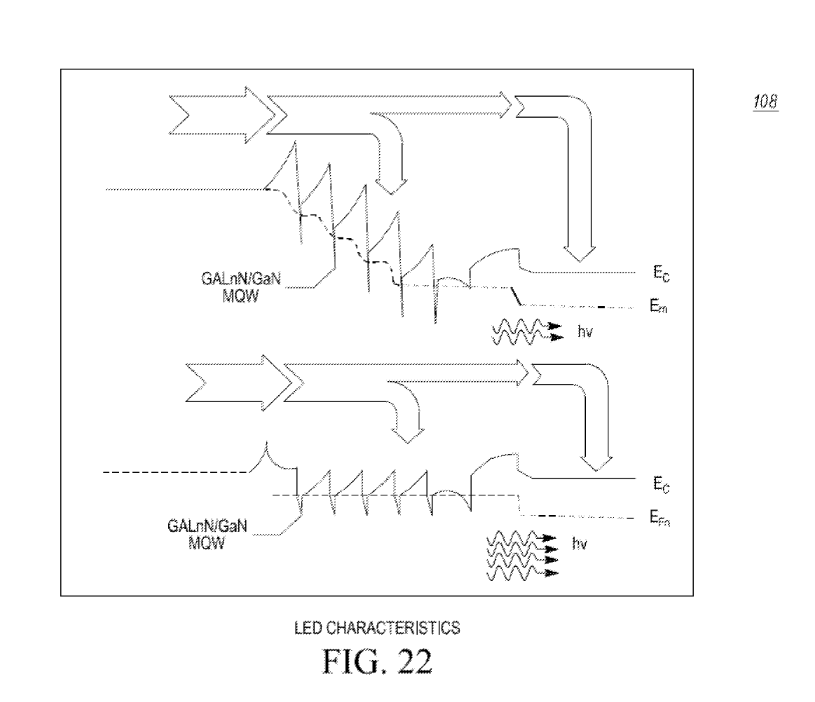

FIGS. 21-22 are illustrative graphs, charts and visuals for illustrating the electrical performance of LEDs that can be used in the illustrative LED lighting systems, methods and applications, according to illustrative embodiments. In FIG. 21, an illustrative LED fabrication process for the LEDs 108 (e.g., a Samsung LED package, including 9 individual LED dies in one package) is shown. In FIG. 21, the LED characteristics of the LEDs 108 are shown, wherein the LEDs 108 are polarization-matched LEDs, exhibiting about an 18 percent increase in light output and about a 22 percent increase in wall-plug efficiency (e.g., which essentially measures the amount of electricity the LED converts into light), as compared to conventional LEDs.

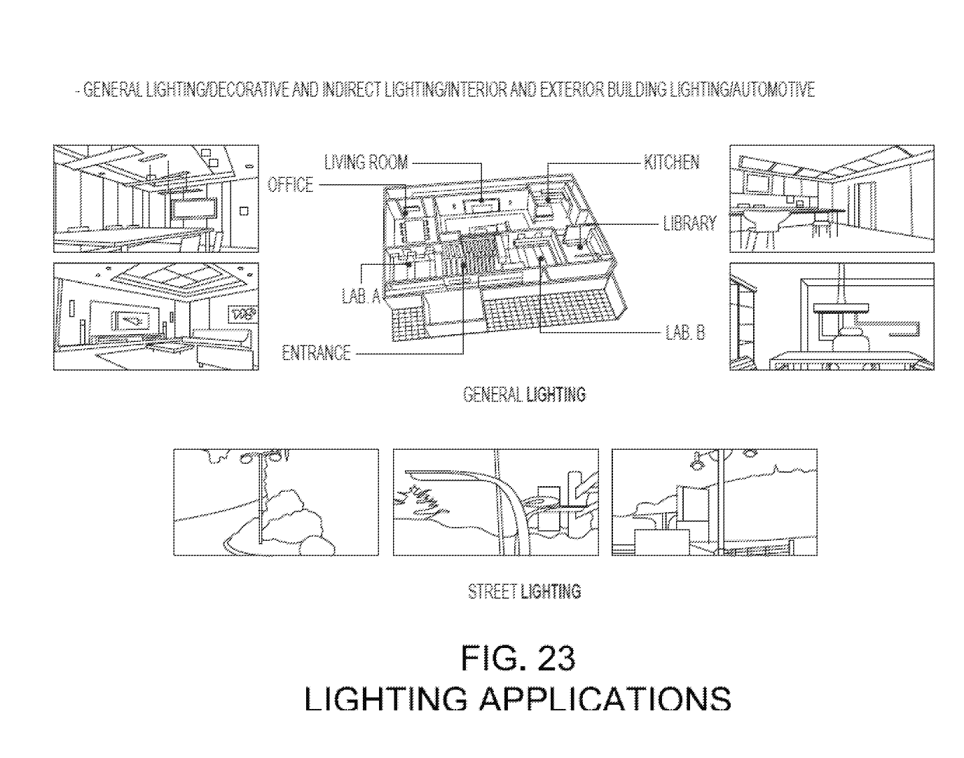

FIG. 23 shows illustrative lighting applications for the illustrative LED lighting systems and methods, according to illustrative embodiments. In FIG. 23, the illustrative LED lighting systems and methods can be used in a variety of applications, including general lighting, street lighting, and the like, applications. For example, the illustrative LED lighting systems and methods can be used in applications for office, inhabitancy, area tunnel, underground passage, railway, underground parking places, parks, advertising boards, roads, industrial buildings, warehousing, markets, courtyards, factories, city streets, pavements, squares, schools and yards, and the like.

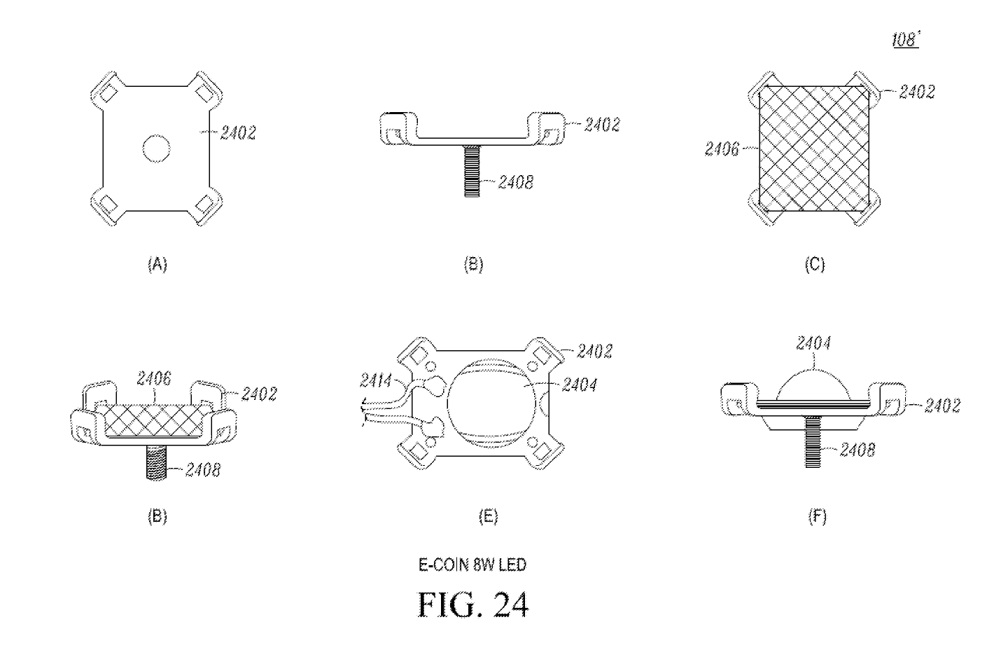

FIG. 24 shows an illustrative e-coin LED that can be used in the illustrative LED lighting systems, methods and applications. In FIG. an e-coin LED 108′ can include a single LED package 2404 (e.g., a Samsung LED package, including a plurality individual LED dies in one package and operating at 8 W) mounted on a metal disk heat sink/base 2402 having a fastener 2408 (e.g., a screw type fastener) and conductive/adhesive pad 2406. The e-coin LED 108′ further includes LED electrical wires 2414 (e.g., for solder wiring). Advantageously, with this design, when the e-coin 108′ is screwed down in place, the stud 1108 provides for ground continuity.

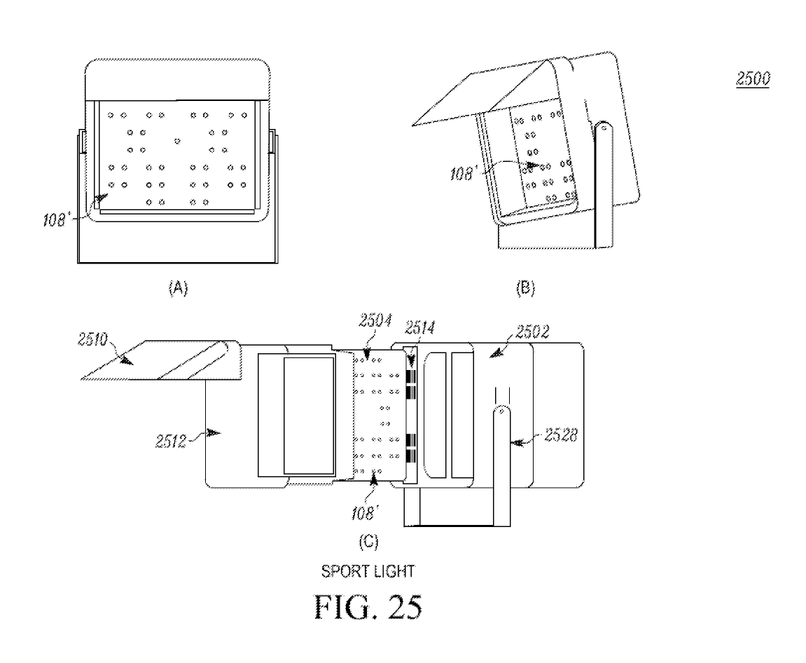

FIG. 25 shows an illustrative sport light fixture that can be used with the illustrative e-coin LEDs, according to illustrative embodiments. In FIG. 25, a sport light fixture 2500 can include housings 2502 for accommodating one or more of the e-coin. LEDs 108′ on PCB or plate 2504, mounting brackets 2528, heatsinks/drivers 2514, reflector or visor 2510, and lens 2512. Advantageously, the sport light fixture 2500 can be used in high output light applications, such as stadium application, flood light applications, and the like.

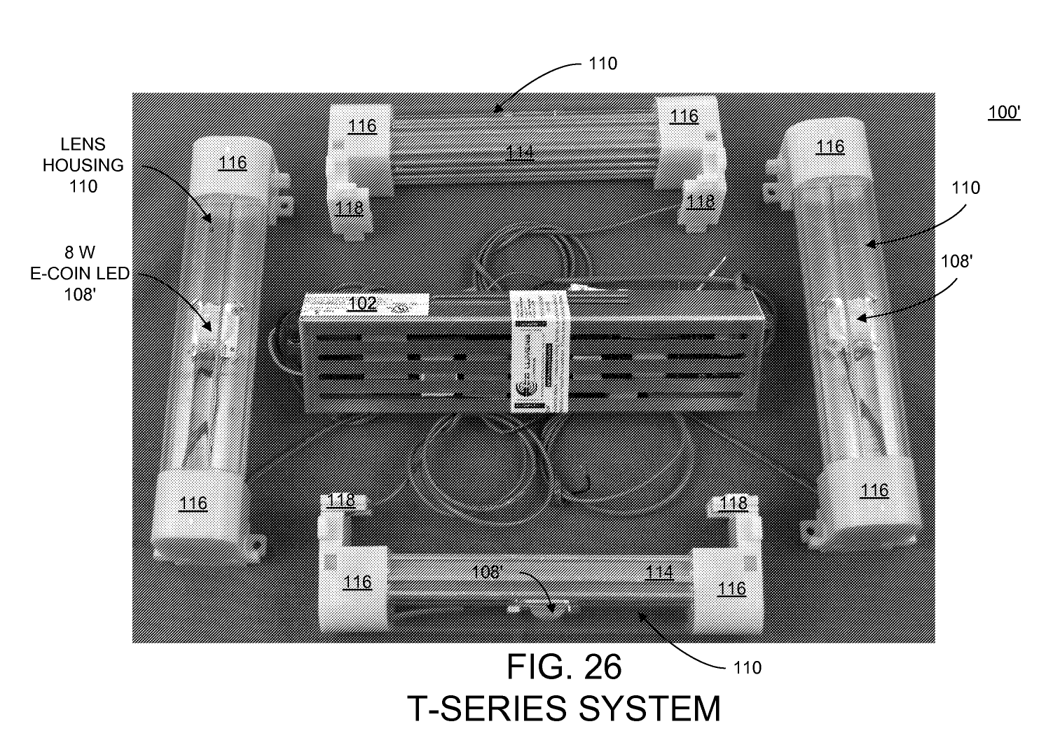

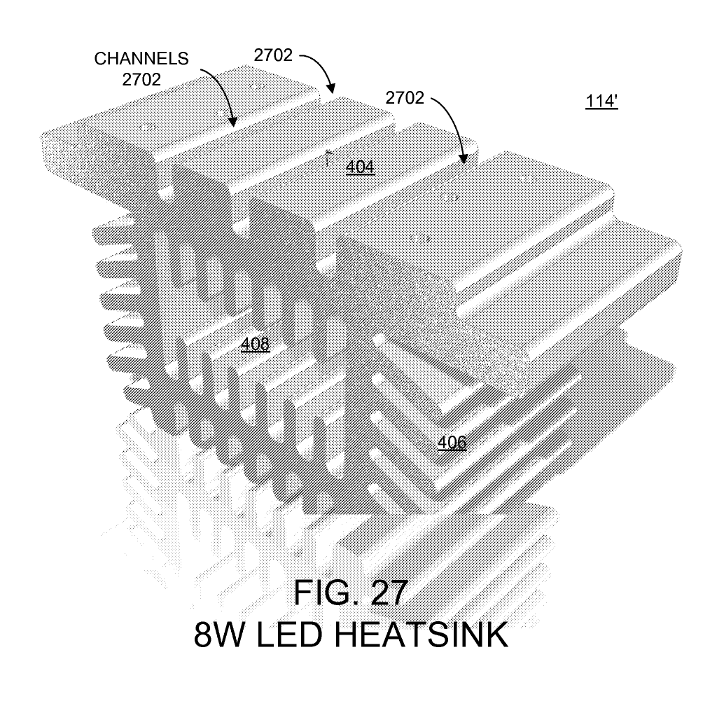

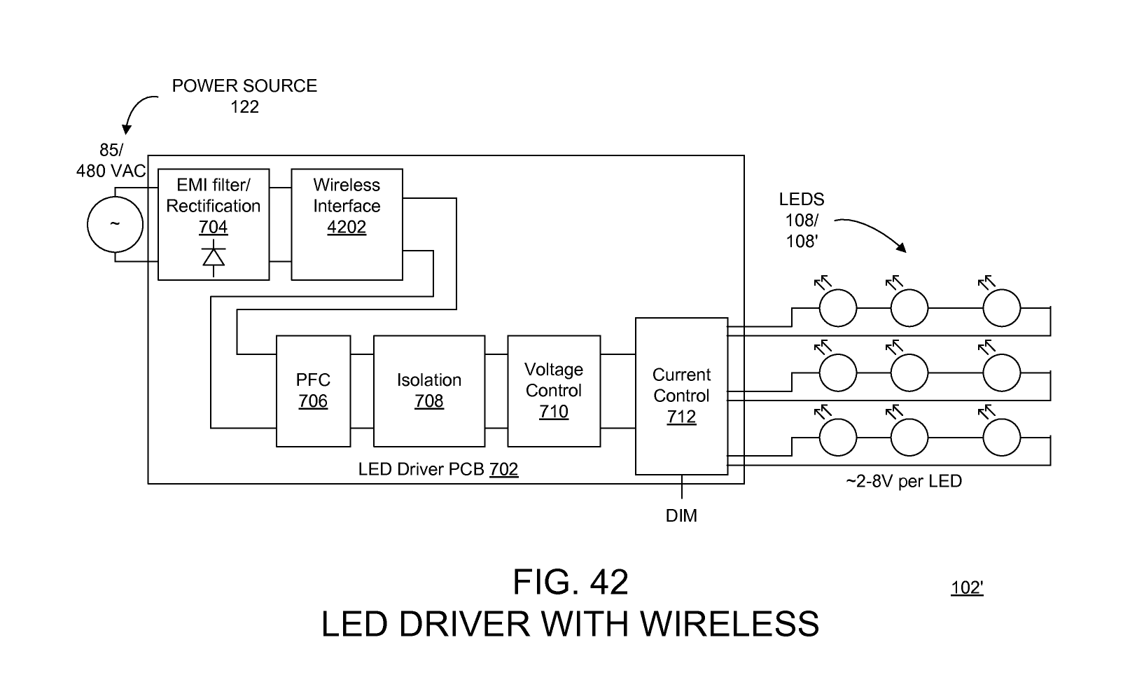

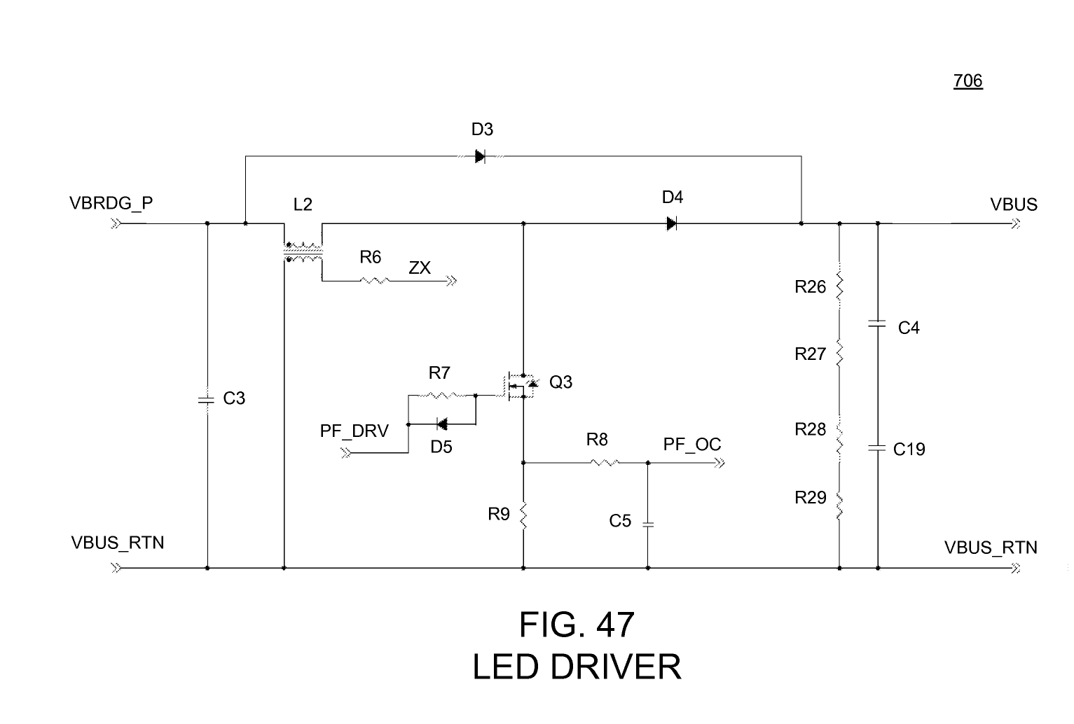

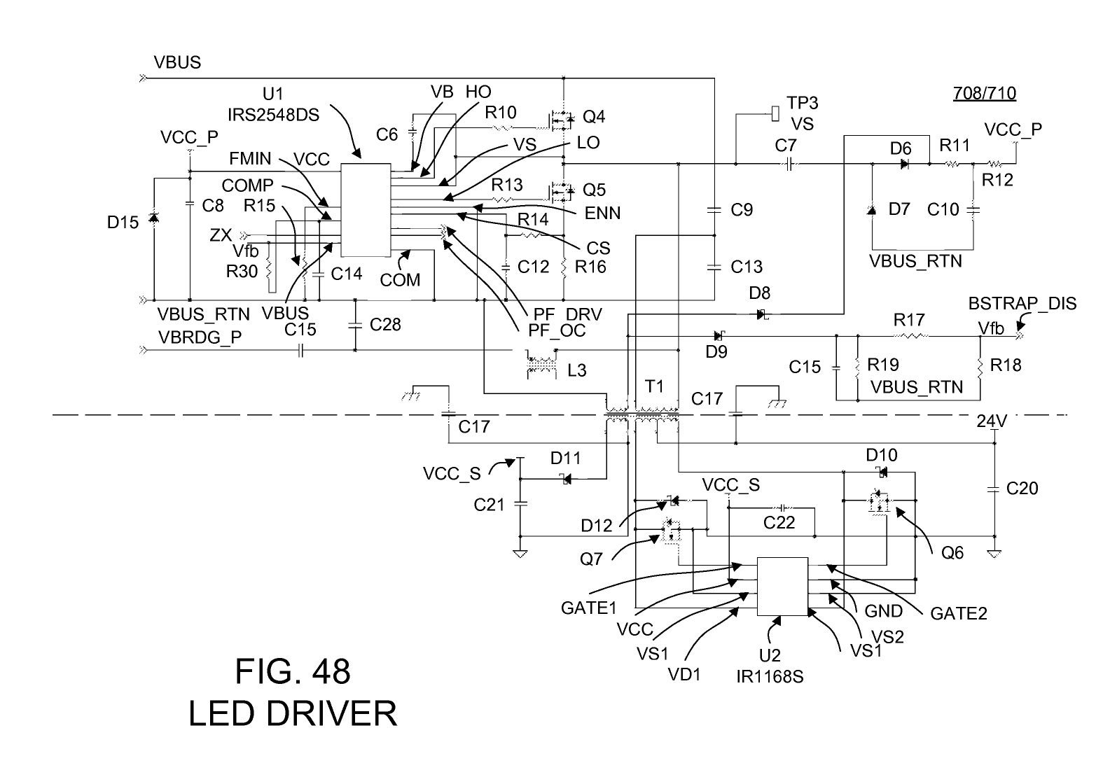

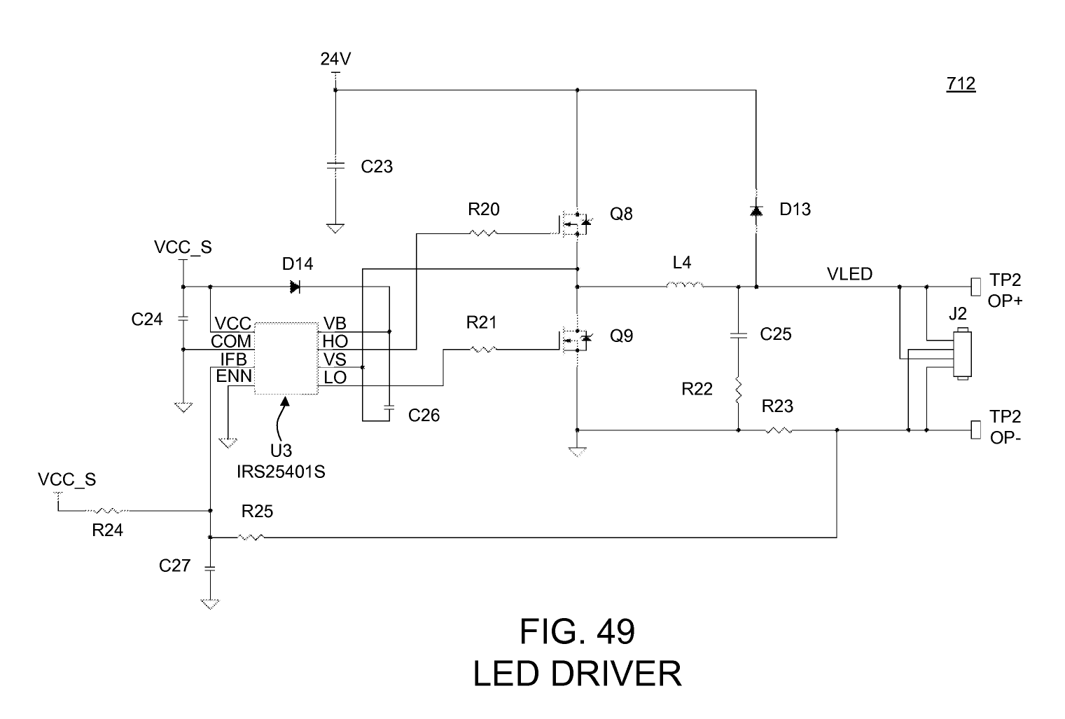

FIG. 26 shows an illustrative LED lighting system and method 100′. In FIG. 26, the LED lighting system can include the driver 102 or 102′ (e.g., as further described in FIGS. 1A, 7-10 and 42-49) configured as a four channel unit for driving four of the T-series lighting sub-systems, including e-coins 108 or 108′ (e.g., as further described in FIGS. 11, 24 and 28), lens housings 110 (e.g., as further described in FIG. 3A), heatsinks 114 (e.g., as further described in FIG. 4A), endcaps 116, and tombstones 118 (e.g., as further described in FIGS. 5-6). The LED lighting system 100′ can be used for new and retrofit applications, and the like. The drivers 102 or 102′ can include wireless functionality (e.g., as further described in FIG. 42) for remote and independent control and monitoring of the respective T-series lighting sub-systems connected thereto.

FIG. 27 shows the illustrative heatsink 114′ of FIG. 14B(C) adapted for use with the illustrative e-coin LEDs. In FIG. 27, the heatsink 114′ (e.g., as further described in FIG. 14B(C) for e-pad applications) also can be used for screw-in, pressure-fit, and the like, mounting of one or more of the e-coins 108 or 108′ (e.g., as further described in FIGS. 11, 24 and 28). The adapted heatsink 114′ can be used in the illustrative LED lighting systems, methods and applications.

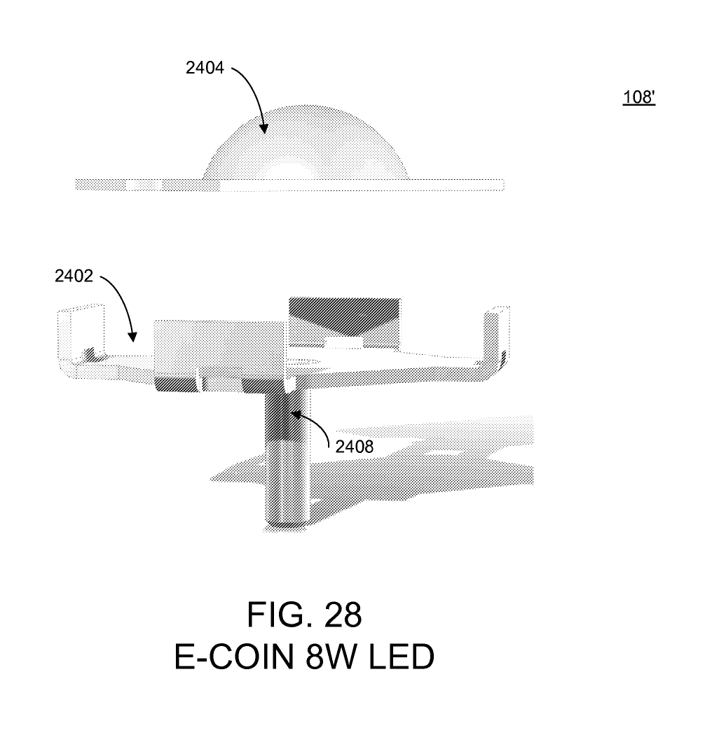

FIG. 28 shows an exploded view of the illustrative e-coin LED of FIG. 24 in further detail and that can be used in the illustrative LED lighting systems, methods and applications (e.g., as further described with respect to FIG. 24).

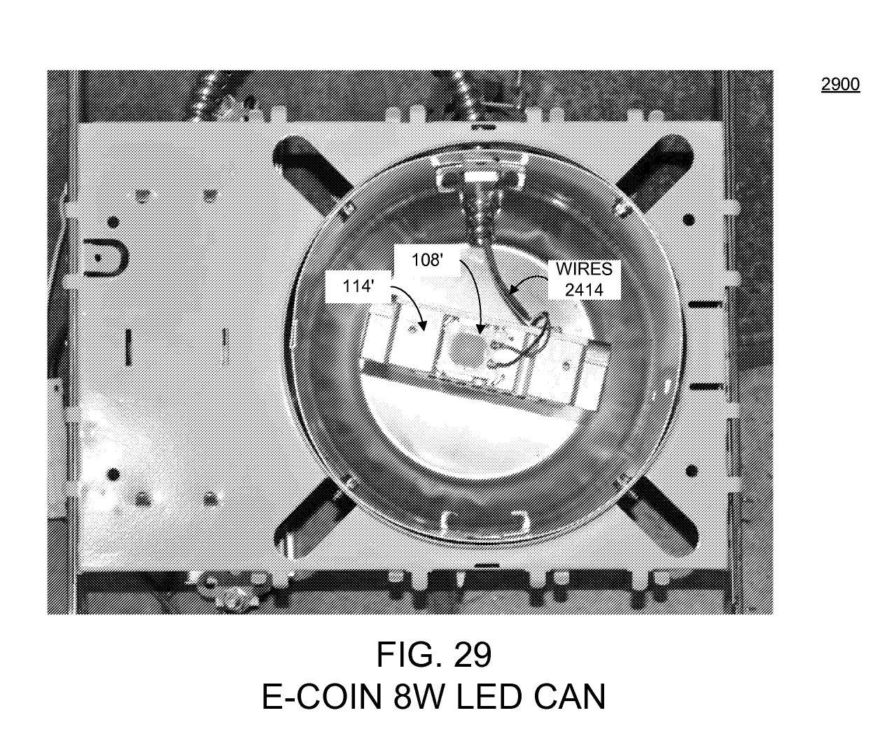

FIG. 29 shows an illustrative can type LED lighting system of FIG. 14B(A) that can be used with the illustrative e-coin LEDs. In FIG. 29, the can type LED lighting system 2900 (e.g., 4″ to 8″ diameter) can include one or more of the e-coins 108 or 108′ with connecting wires 2414 (e.g., as further described in FIGS. 11, 24 and 28), and the heatsink 114′ (e.g., as described in FIG. 27). For example, when the can type LED lighting system 2900 is used in an application with a ceiling height of 8 FT to 15 FT, one of the e-coins 108′ (e.g., operating at 8 W) or two of the e-coins 108 (e.g., operating at 5 W each) can be employed, and with a ceiling height of 15 F to 25 FT, two of the e-coins 108′ can be employed or three of the e-coins 108. Accordingly, various ceiling heights can be accommodated, by employing a suitable number of the e-coins 108 or 108′.

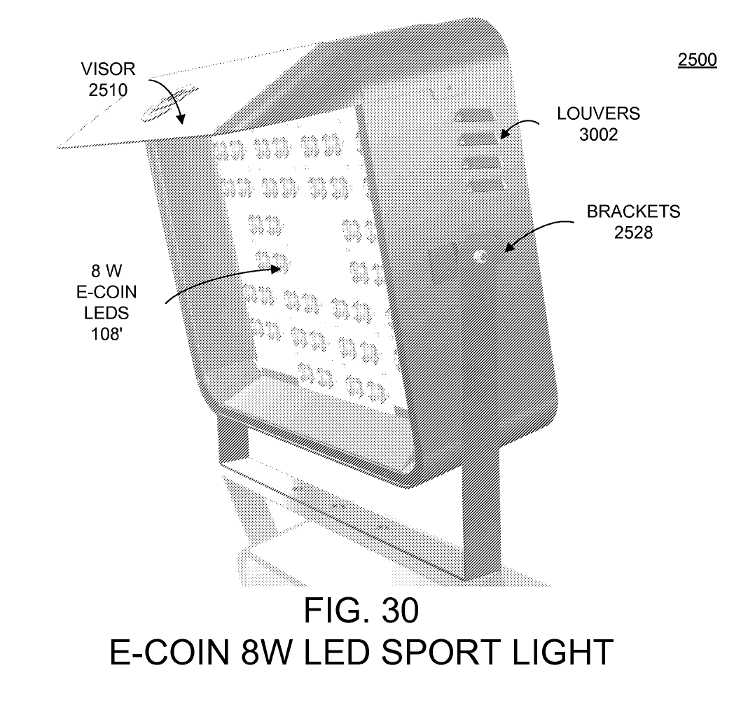

FIGS. 30-36 show further features and details of the illustrative sport light fixture of FIG. 25 that can be used with the illustrative e-coin LEDs. In FIG. 30, the illustrative sport light fixture 2500 (e.g., as described in FIG. 25) can further include louvers 3002 for cooling, and for example, forty eight of the e-coin LEDs 108′ or 108 (e.g., operating at 8 W each and configured twelve sets of four). Advantageously, by using a suitable number and pattern of the e-coin LEDs 108′, or 108 various types of lighting footprints can be generated (e.g., IES type 1, 2, 3 and 5 footprint patterns). The e-coin LEDs 108′ or 108 of the sport light fixture 2500 are configured to connect to respective driver circuits 102 (not shown) in a drivers housing (not shown) that can be remotely located.

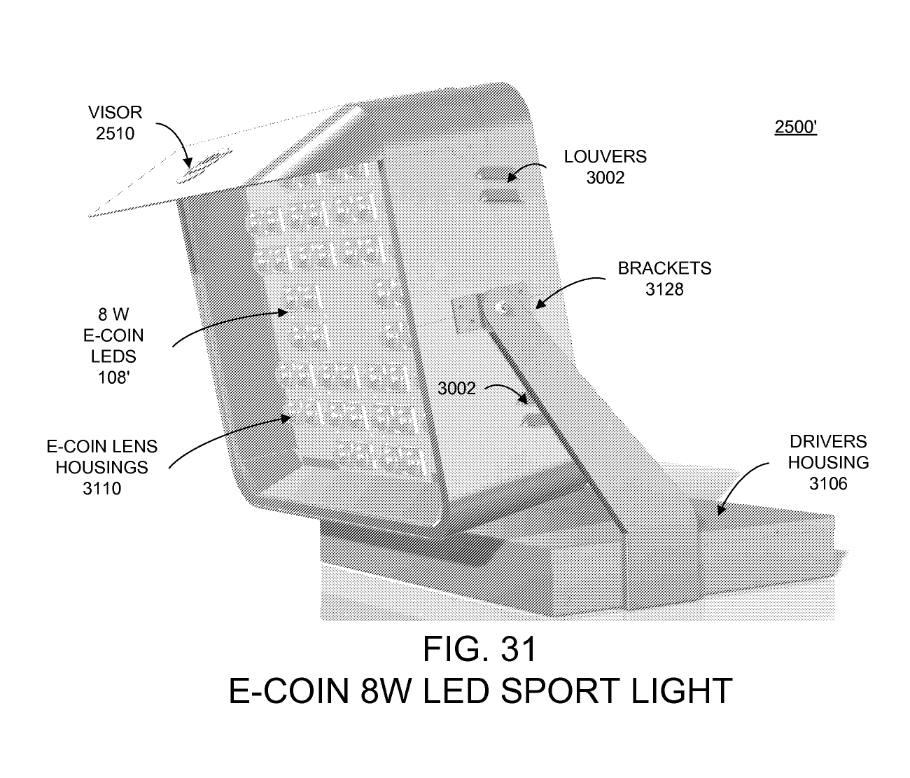

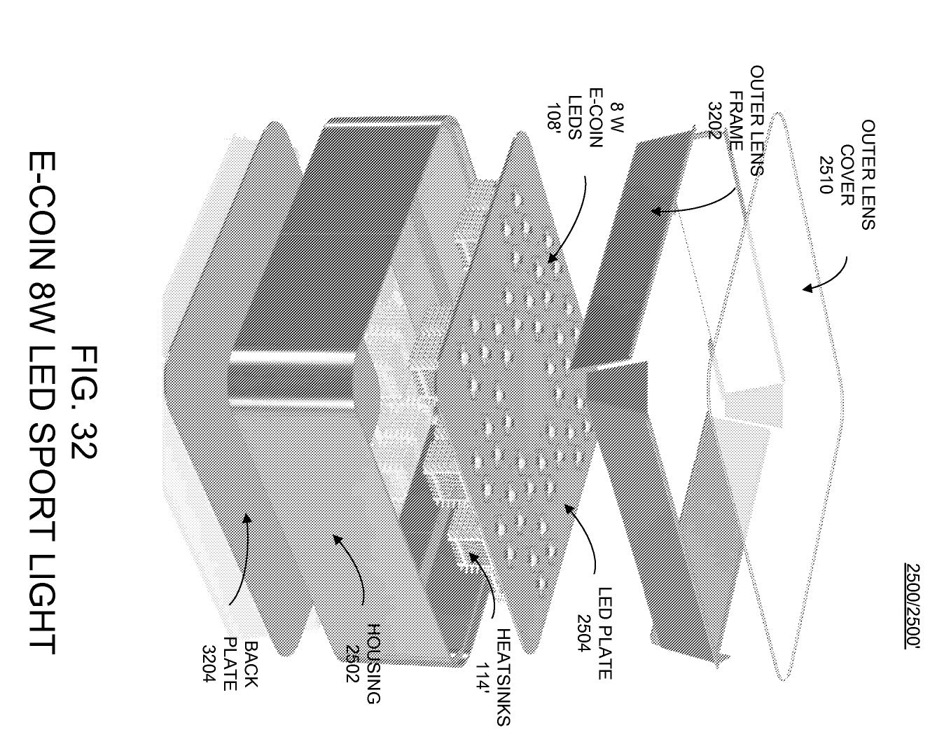

In FIG. 31, the illustrative sport light fixture 2500′ can further include brackets 3128 for connecting the sport light fixture 2500′ to a drivers housing 3106 (e.g., which can be detached and remotely located). The e-coin LEDs 108′ or 108 of the sport light fixture 2500′ are configured to connect to respective driver circuits 102 (not shown) contained within drivers housing 3106. The e-coin LEDs 108′ or 108 of the sport light fixture 2500′ each include respective e-coin LED lens housing 3110 for providing further light amplification and uniform light spread.

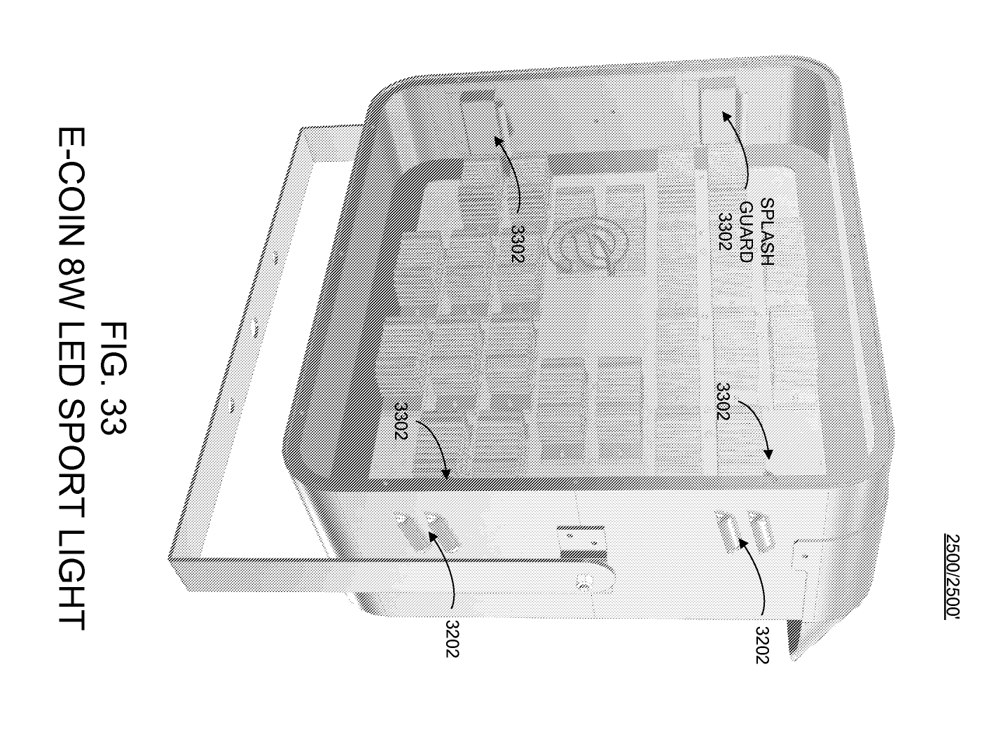

In FIG. 32, the illustrative sport light fixture 2500 or 2500′ is shown in an exploded view. For example, the sport light fixture 2500 or 2500′ can include the e-coin LEDs 108′ or 108′, the respective heatsinks 114′, the housing 2502, the LED plate 2504, the outer lens cover 2510, an outer lens frame 3202 and a back plate 3204.

In FIG. 33, the illustrative sport light fixture 2500 or 2500′ is shown in a rear view. For example, the sport light fixture 2500 or 2500′ can include the respective the louvers 3202 with respective splash guards 3302 for preventing rain, water, and the like, from entering the sport light fixture 2500 or 2500′.

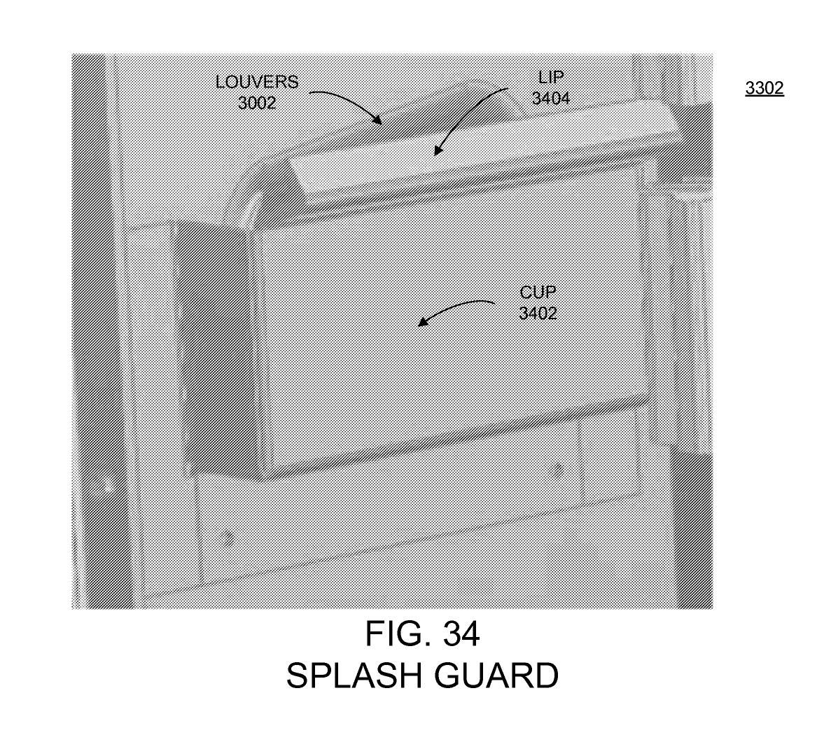

In FIG. 34, further details of the splash guards 3302 are shown. For example, the splash guards 3302 can include a cup 3402 and a lip 3404. Water, rain, and the like, entering through the louvers 3002 is deflected by the lip 3404 into the cup 3402 and then drains back out through the louvers 3002.

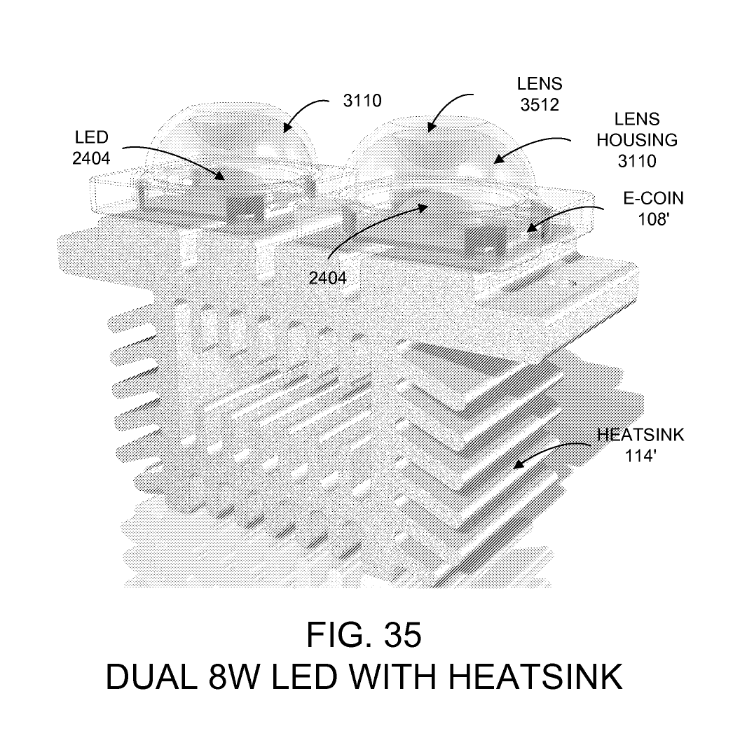

In FIG. 35, further details of the lens housing 3110 are shown. For example, the lens housing 3110 can include a lens 3512 removeably attachable to the e-coin LED 108′ or 108 connected to the heatsink 114′. The lens 3512 lines up with the LED 2404 to provide magnification, light spreading, and the like (e.g., as further described with respect to FIGS. 3A-3B).

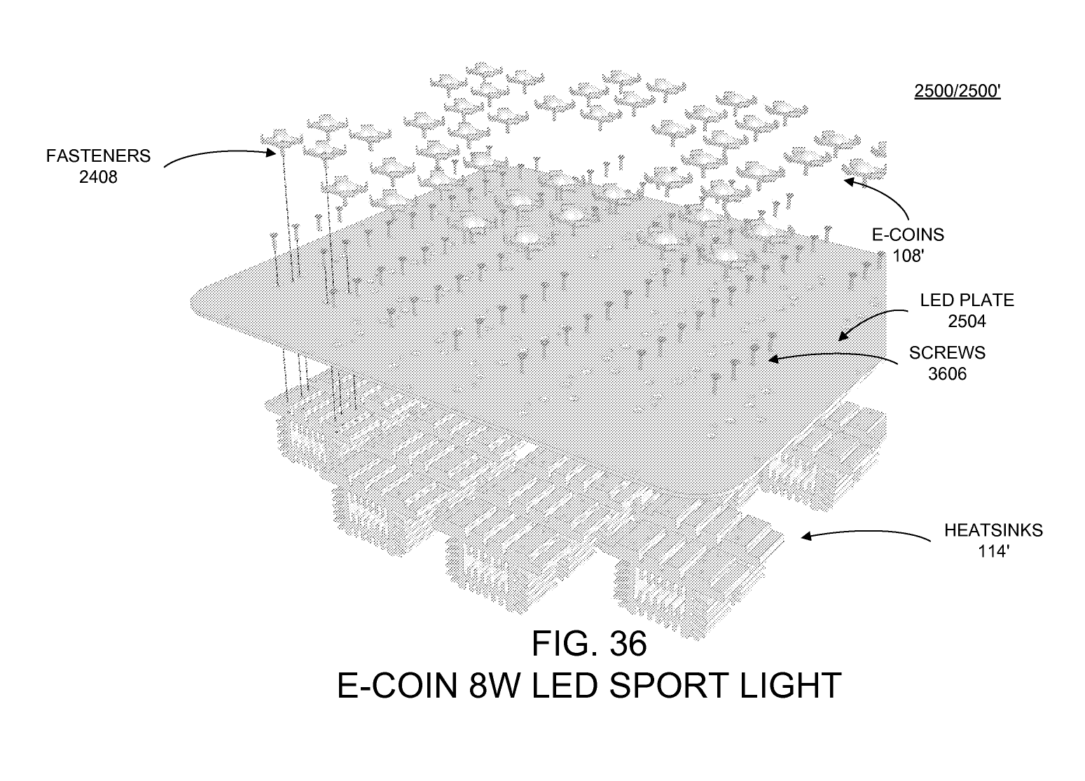

In FIG. 36, the illustrative sport light fixture 2500 or 2500′ is shown in an exploded view. For example, the sport light fixture 2500 or 2500′ can include the e-coin LEDs 108′ or 108′ removeably attached through the LED plate 2504 to the respective heatsinks 114′ with the fasteners 2408. The LED plate 2504 also is screwably attached to the heatsinks 114′ with fasteners 3606 (e.g., a screw type fastener).

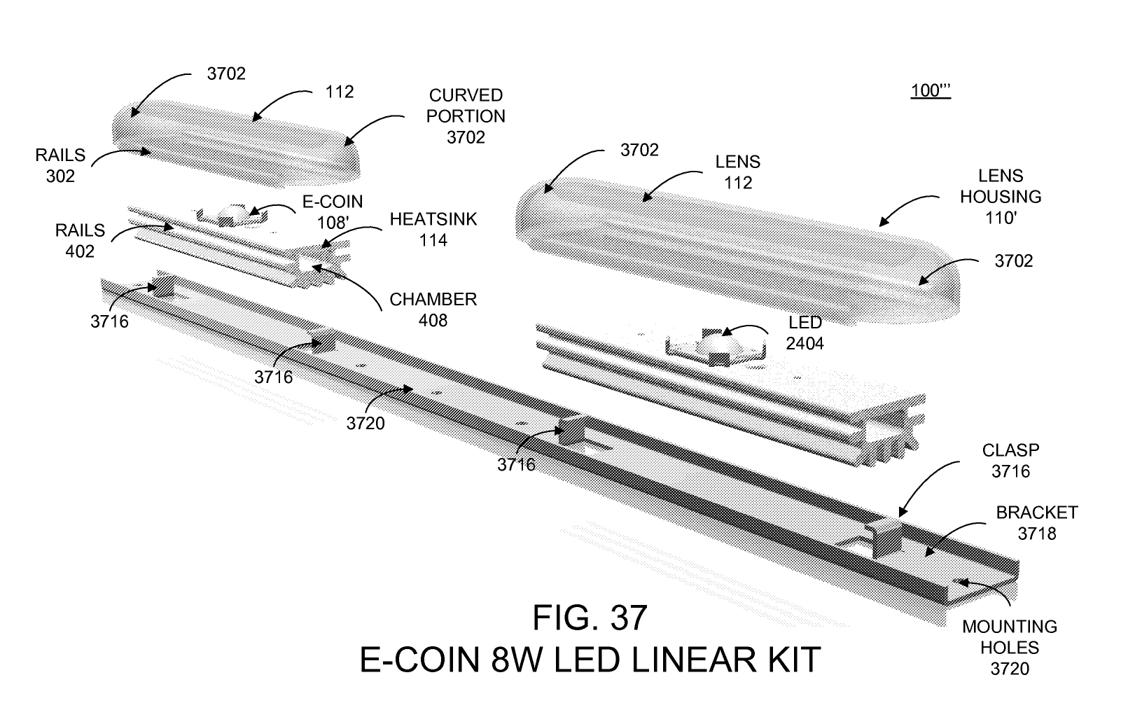

FIGS. 37-41 show further illustrative LED lighting system and method 100′″. In FIG. 37, the LED lighting system 100′″ operates in a similar manner as the LED lighting system 100 described in FIGS. 1A, 3A and 4A. For example, the LED lighting system 100′″ can include the heatsinks 114 with rails 402 (e.g., as further described with respect to FIG. 4A) removeably attached to respective rails 302 of a lens housings 110′ having the lenses 112 (e.g., as further described with respect to FIG. 3A). The lens housing 110′ further includes curved portions 3702 for providing uniform light spreading, and the like. One or more of the e-coin LEDs 108′ or 108′ having LEDs 2404 are removeably attached to the respective heatsinks 114. The chambers 408 of the heatsinks 114 are removeably attached to respective clasps 3716 of a mounting bracket 3718 having mounting holes 3720 for removable attachment to walls, ceiling, and the like. The mounting bracket 3718 also be configured for a single LED lighting system 100′″ as compared to the dual LED lighting system 100′″ shown in FIG. 37.

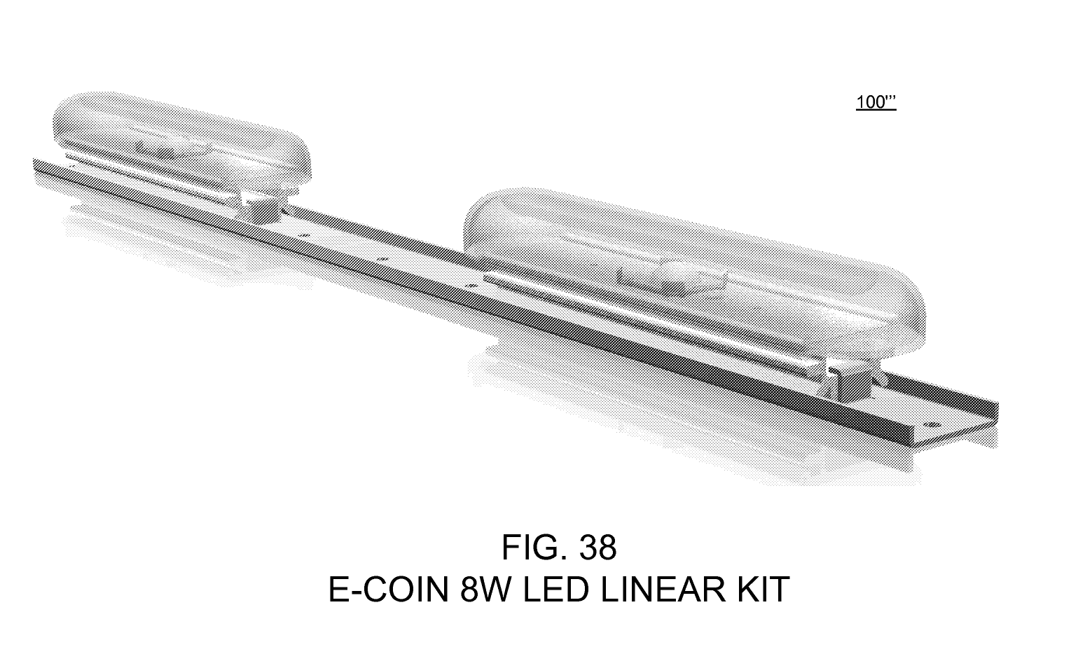

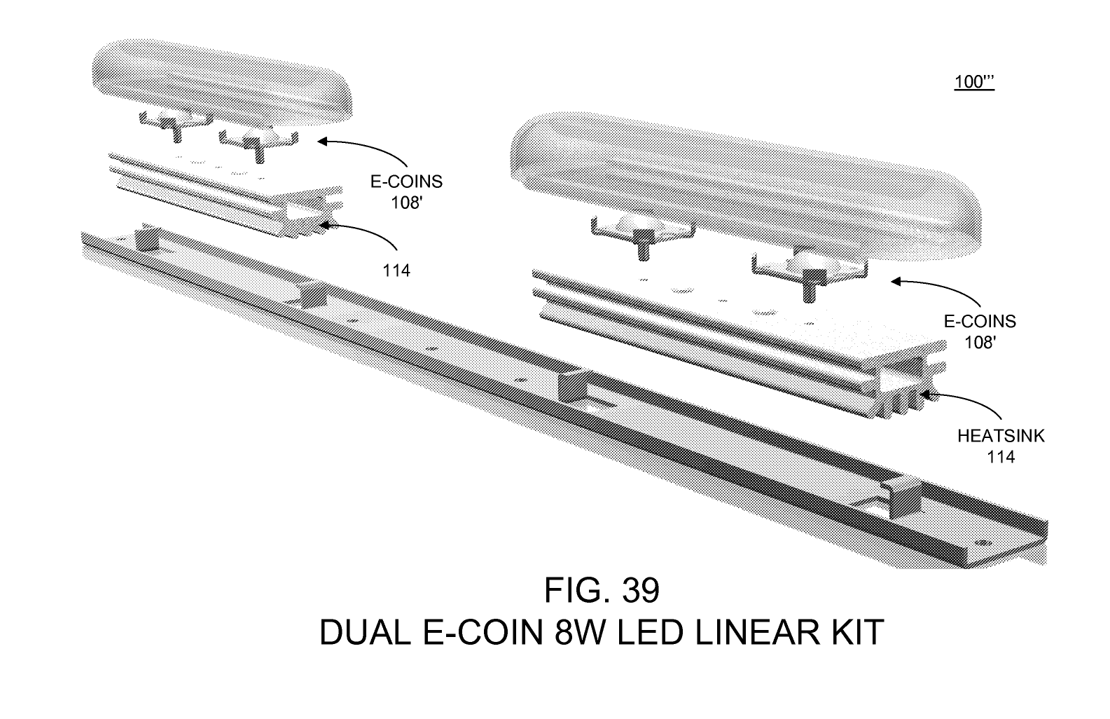

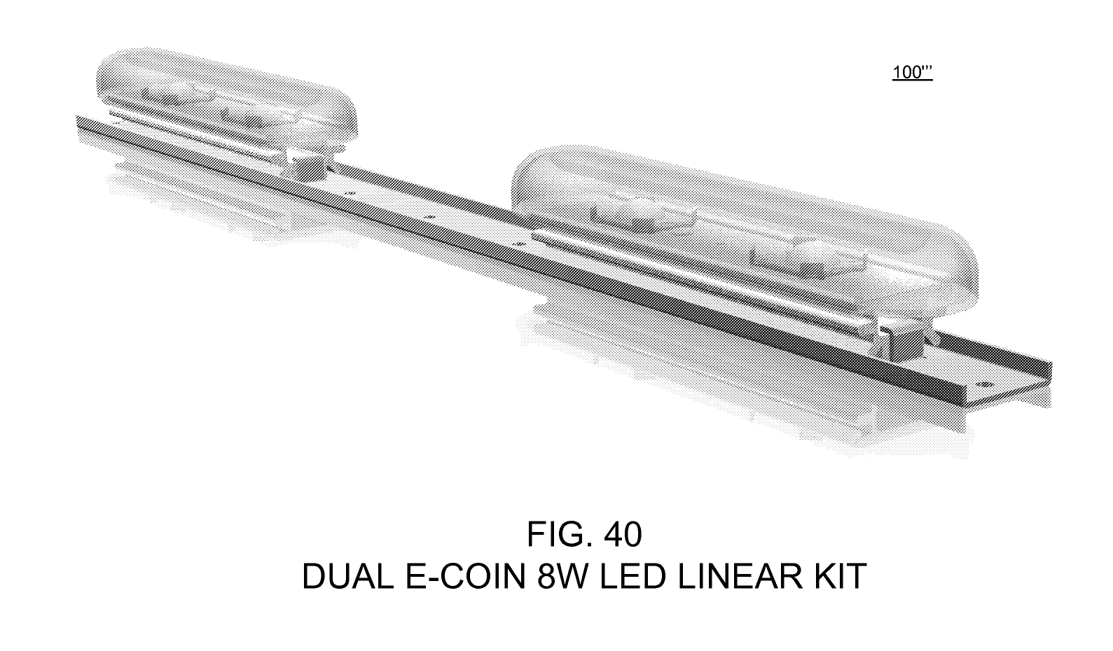

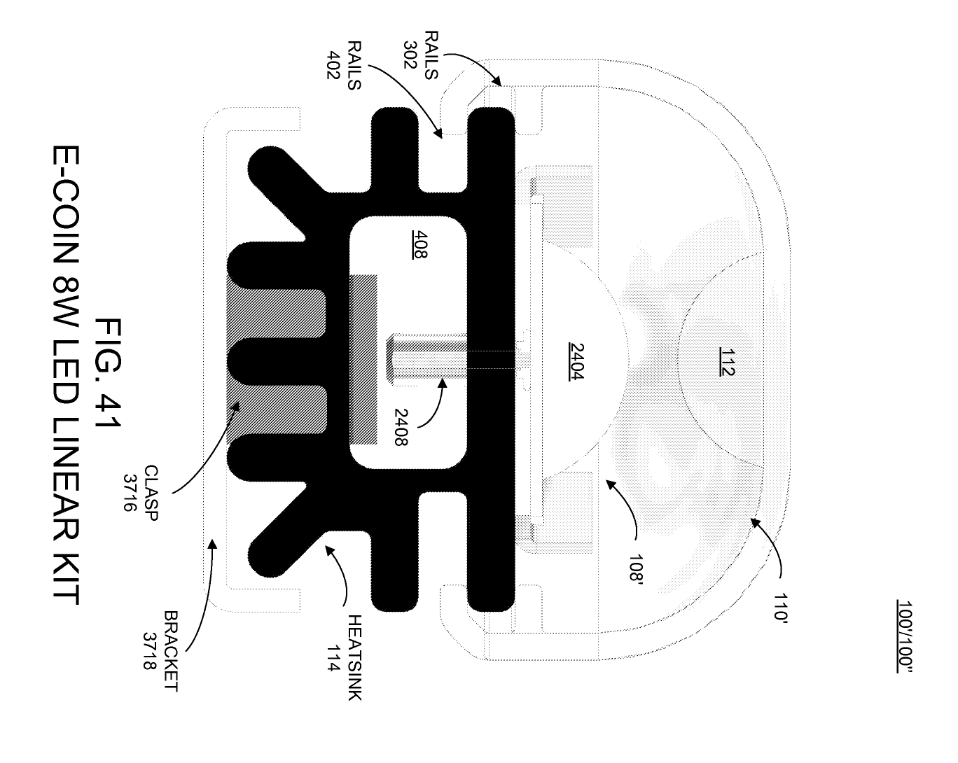

In FIG. 38, the dual LED lighting system 100′″ of FIG. 37 is shown in an assemble form. In FIG. 39, the dual LED lighting system 100′″ of FIG. 37 is shown including two of the e-coin LEDs 108′ or 108′ for mounting on each of the heatsinks 114. In FIG. 40, the dual LED lighting system 100′″ of FIG. 40 is shown in an assemble form.

In FIG. 41, the dual LED lighting systems 100′″ of FIGS. 37-40 are shown in a side view. For example, the LEDs 2404 of the e-coin LEDs 108′ or 108′ are optically aligned with the lenses 112 of the lens housings 110′. The lenses 112 of the lens housings 110′ are removable attached to the heatsinks 114 with rails 302 and 402. The e-coin LEDs 108′ or 108′ are removeably attached to the heatsinks 114 with posts 2408. The heatsinks 114 are removeably attached to the mounting bracket 3718 with clasp 3716 and chambers 408.

FIGS. 42-49 show further illustrative drivers for the illustrative LED lighting systems and methods. In FIGS. 42-49, the drivers operate in a similar manner as the driver 102 described in FIGS. 7-10, except as noted. For example, in FIG. 42, a AC/DC driver 102′ further includes a wireless interface 4202 coupled between the electromagnetic interference (EMI) filter/rectification circuit 704, and the power factor correction (PFC) circuit 706. The wireless interface 4202 can be configured for any suitable wireless communications (e.g., spread spectrum, Wi-Fi, RFID, UHF, VHF, etc) and include a suitable controller, memory and memory interfaces (SD, micro-SD, etc.).

The wireless interface 4202 can be configured as a repeater, base station, hot spot, and the like, and used for control and monitoring functions for the illustrative LED lighting systems and methods. For example, the wireless interface 4202 can be used to control and monitor voltage, current, phase, amplitude, dimming, light detection circuits, operational information, trending, life time, and the like, of the drivers and respective channels of the illustrative LED lighting systems and methods. By employing colored lens in the illustrative LED lighting systems and methods, the wireless interface 4202 can be used to enable advanced lighting effects for providing stage lighting effects, strobing effects, and the like. The wireless interface 4202 can include any suitable software, drivers, applications, operating systems (OS), and the like (e.g., for Windows OS, UNIX OS, Android OS, Apple OS, Blackberry OS, etc).

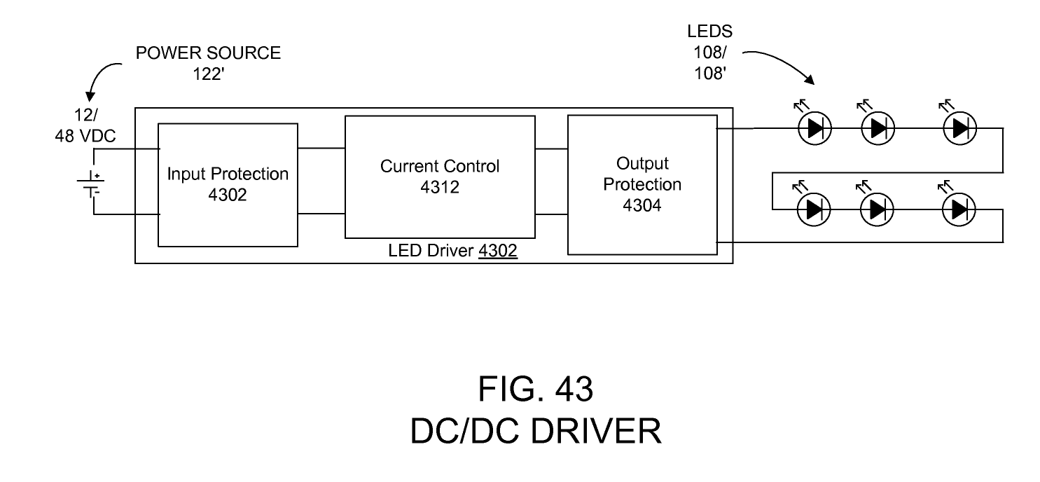

FIG. 43 shows a DC/DC LED driver 4302. In FIG. 43, the DC/DC LED driver 4302 can include input protection circuit 4302 (e.g., internal fuse of 3 Amps and reverse polarity input protection), current control circuit 4312 (e.g., line regulation of 50 mA over 21 VDC to 32 VDC range), and output protection circuit 4304 (e.g., short circuit protection, protection against connection of output to battery for either polarity).

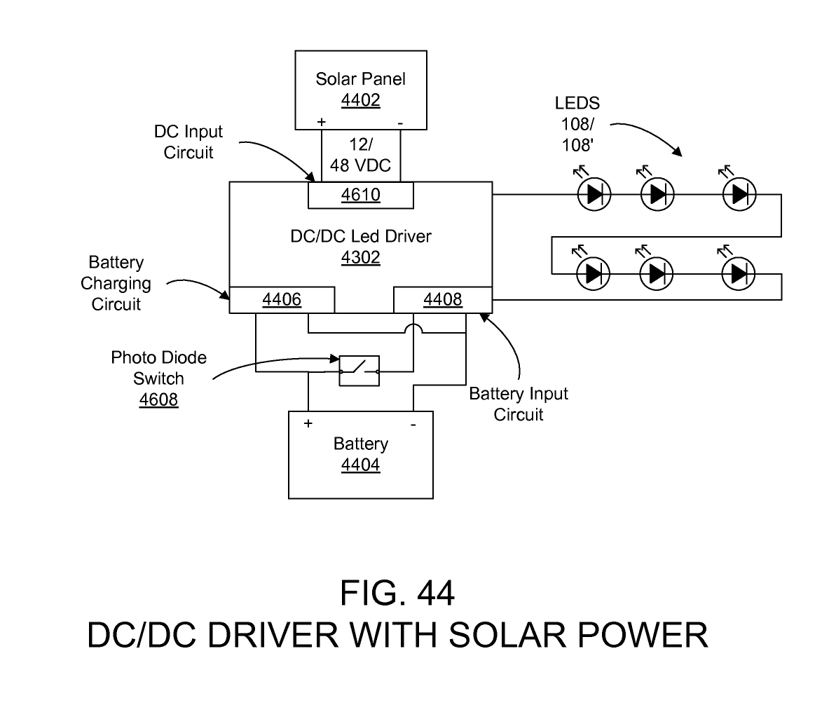

FIG. 44 shows the DC/DC LED driver 4302 of FIG. 43 coupled to a solar panel 4402 and battery 4404. In FIG. 44, the DC/DC LED driver 4302 can include a DC input circuit 4610 coupled to the solar panel 4402, and a battery charging circuit 4406 and battery input circuit 4408 coupled to the battery 4404, as shown. A photo diode switch 4602 is coupled between the positive terminals of the battery charging circuit 4406 and the battery input circuit 4408 for charging the battery during the day and employing battery backup during the night. Such a solar powered LED lighting system can employed at a permanent location or on a small trailer with suitable LED lights to provide fixed or portable lighting for emergency applications, camping applications, military applications, and the like.

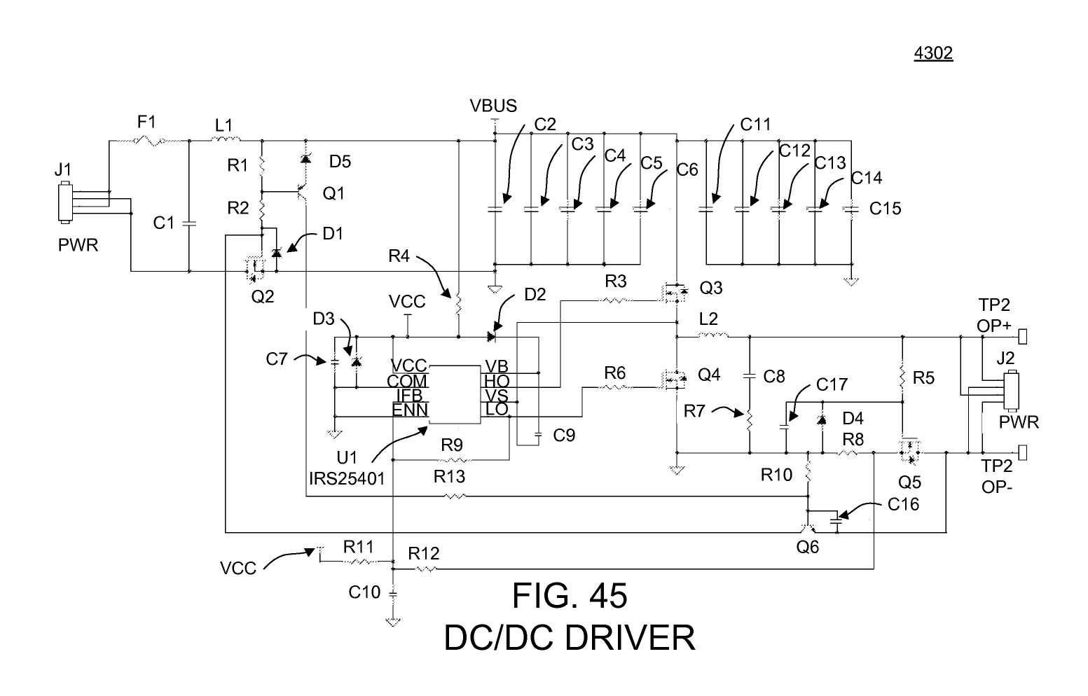

FIG. 45 is an illustrative schematic diagram for the DC/DC LED driver 4302 of FIGS. 43-44.

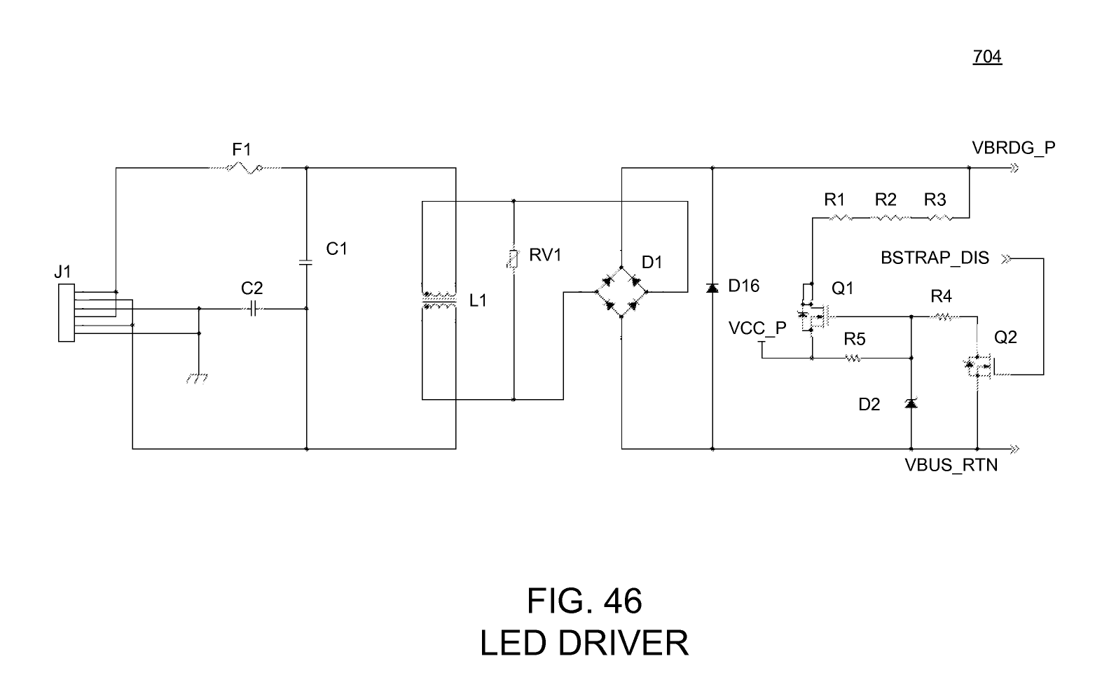

FIGS. 46-49 are illustrative schematic diagrams for the AC/DC LED driver 102 of FIGS. 7-10 and 102′ of FIG. 42.

The AC/DC LED driver circuits and methods of the illustrative embodiments include numerous advantages over conventional AC/DC LED driver circuits, and can be configured to, for example, be dimmable, operate with an input voltage range of 85 to 480 VAC (rms) at 50/60 Hz, operate with an input power (e.g., nominal) of 35 W, operate with a Power Factor (PF) of greater than 0.9, operate with Total Harmonic Distortion (THD) of less than 20% (e.g., of line input current), operate with input protection employing an internal fuse (e.g., 1 Amp), operate with a maximum output voltage of 24 VDC, operate with a typical output voltage of 20 VDC (e.g., when not dimmed), operate with an output current of 1.44 A (e.g., nominal, when not dimmed), operate with a minimum dim level of 20% (e.g., dimmable with suitable dimmer types), operate with an output type that us isolated, operate with output protection via short circuit protection, operate at an ambient temperature range of −20 to 50 degrees C., operate with a maximum case temperature of 85 degrees C., and the like.

The DC/DC LED driver circuits and methods of the illustrative embodiments include numerous advantages over conventional DC LED driver circuits, and can be configured to, for example, operate with a maximum power rating of 30 W, operate with a typical output voltage of 18.7 VDC (e.g., for an EPAD with 16 5 W LEDs, for four E-Coins with 8 W LEDs), operate with a minimum input voltage of 21 VDC, operate with a maximum input voltage of 32 VDC, operate with an output current of 1.35 A (e.g., regulated output current), operate with line regulation of 50 mA (e.g., over 21 VDC to 32 VDC range), operate with efficiency at 24 VDC input of 94%, operate with efficiency of greater than 90% over input range of 21 VDC to 32 VDV (e.g., for an EPAD with 16 5 W LEDs, for four E-Coins with 8 W LEDs), operate with an input current at 24 VDC of 1.12 A, operate with battery reverse polarity protection, operate with protection against accidental connection of battery to output in either polarity, operate with a preheat frequency, operate with a preheat time, operate with a closed-loop ignition current regulation, operate with a closed-loop ignition regulation for reliable lamp ignition, operate with ultra low THD, operate with a lamp removal/auto-restart function, operate with a front end circuit LED driver based on IR HVIC combo chip (e.g., PFC+High/Low side driver), operate with current regulation via an LED Buck Regulator Control IC, operate with an output operating frequency of greater than or equal to 120 Hz, operate with synchronous rectification to increases efficiency in high output current applications, and the like.

In addition, the DC/DC LED driver circuits and methods with solar power of the illustrative embodiments include numerous advantages over conventional solar powered DC/DC LED driver circuits, and can be configured to, for example, operate with an input voltage range of 22 VDC to 30 VDC (e.g., will operate at reduced output down to 18 VDC), operate with an input power (e.g., nominal) of 35 W, operate with input protection via an internal fuse (e.g., 3 Amp), operate with reverse polarity input protection, operate with a maximum output voltage of 20 VDC, operate with an output current of 1.5 A, operate with an output type being non-isolated (e.g., safety low voltage), operate with output protection via short circuit protection, operate with protection against connection of output to battery (e.g., either polarity), operate with an ambient temperature range of −20 to 50 degrees C., operate with solar controller functionality, for example, including a rated solar input of 6 amps/12 amps, a nominal system voltage of 24 VDC, a minimum battery voltage of 0 VDC, a maximum solar input voltage of 48 VDC, self-consumption charging of 2-7 mA (e.g., night), voltage accuracy of ±150 mV battery charging, regulation voltage of 26.1 VDC (e.g., at 25° C.), float voltage of 25.7 VDC (e.g., at 25° C.), type of charging series PWM 3 stage (e.g., bulk, PWM and float), and the like.

The illustrative lenses and lens housing of the illustrative LED lighting systems and methods include suitable parabolic, prism, light redirection, and the like, functions for reducing or eliminating hot spots caused by the light output from the LEDs. In addition, the plastic formulations thereof can include suitable additives, such as polymers, and the like, to further reduce the hot spots.

The LED lighting systems and methods of the illustrative embodiments include numerous advantages over conventional lighting systems and methods, including:

Energy Efficiency—LED lights burn very cool, while incandescent bulbs emit 98 percent of their energy as heat. Though currently more expensive to purchase up front, LED lighting saves in long-term operational costs and meets the new standards set forth by ASHRAE and others using a low wattage solid state system. LEED points are easily achievable when lighting a facility with an LED lighting system outdoors or indoors. Directionality and usable lumens make LED lighting systems and advantageous choice.

Long Life—LED lighting systems can last up to 100,000 hours. Incandescent light bulbs typically last around 1,000 hours and fluorescents are good for roughly 10,000 hours, wherein there is a substantial difference between the definitions of L70 Lifespan for LED lighting, and Average Lifetime of traditional lighting.

Rugged Durability—LED lights have no fragile filament to contend with, and no fragile tube. They are resistant to heat, cold, and shock. Solid state in nature, LED lighting is far more durable than any other type of lighting. No filaments, gases or thin glass ensures savings in breakage and shorter life due to ambient forces like wind, vibration, movement, and human error.

Shock Resistant—Unlike typical conventional light sources, LEDs are not subject to sudden failure or burnout as there are no filaments to burn out or break. In LEDs, the light emits from fully encapsulated silicon diodes immersed in phosphor, which can be energized from a very low voltage input.

Lumens per Watt (LPW)—While manufacturers are still finding new ways to increase this ratio, they have been able to produce in research an LED that generates 130 lumens/watt. Available LEDs are averaging from 50 to 90 lumens/watt, and incandescent bulbs are at about 15 lumens/watt.

LED Technology Reduces Carbon Emissions—Unlike incandescent, fluorescent or HID light bulbs, the LED lights are environmentally safe and ecologically friendly. There are no poisonous elements used in component manufacture, such as mercury or other noxious and polluting gases or substances (e.g., carbon dioxide, sulfur oxide). The LED lights reduce pollution and as such do not leach harmful poisons into the earth and atmosphere. The LED lights are re-usable, so they won't end up in a landfill, whereas special disposal costs must be taken into consideration with other types of lighting systems.

Compatibility—LED lighting is compatible with most systems. Some models screw in, replacing incandescent bulbs. Others can replace halogen bulbs, fluorescent tubes or high intensity discharge (HID) lamps.

Unparalleled Maintenance Savings—When determining lighting upgrade, the maintenance saving is a major factor in return on investment. Although important, many financial analysis overlook this factor altogether. Total system and total cost must be considered. The typical total life of 50,000 hours per unit with minimal degradation of light output with LED lighting eliminates the cost of periodic re-lamping and regular maintenance. LED units are also tamper/vandal proof.

Control Options—LED lighting systems can be used in conjunction with occupancy sensors and other lighting controls like dimmers, daylight controls and intelligent computer based programs. This has the potential to increase the life of a lighting system exponentially.

Eliminating Light Pollution—Light Pollution is virtually eliminated as light output from LEDs is directional, only directing light where it is required. This is highly efficient as no light is wasted when compared to conventional lighting where light is typically omni-directional from bulbs or tubes. Beams are available from 2°-135° for specific light guidance from light source. Directionality is an important feature of LED lighting, putting the light where needed.

Versatility—LED solid state lighting can be packaged in a variety of ways that were formerly impossible. Over the years, luminaries' manufacturers found innovative ways to take a generally dispersed light and direct it where they want it. SSL (Solid state lighting) makes it possible to entirely re-think both luminaries form factor, and installation methods.

No Need to Hold an Inventory of Different Types of Lamps—Once an LED lighting system is installed, there is not any need to store lamps. The LED lighting system offers lighting with interchangeable LED e-coins, epads, and drives, and with all other parts being reusable.

Installation Costs—As LED lighting becomes more widely used, many installation techniques can be changed where lighting is concerned. New development and building projects can save costs incurred with electrical construction of lighting systems. The low voltage operation of LED lighting allows for a multitude of low material cost design options.

Color Changing Ability—In applications where color is needed, LED lighting can be intelligently controlled, allowing virtually millions of color possibilities.

Lower Total Cost of Ownership (TCO)—LED lighting systems provide for cost effective, long term, outright cost of ownership with minimal initial system outlay when used as a replacement light supply using reduced voltage mains power (e.g., 110 Vac or 240 Vac converted to 12 Vdc or 24 Vdc). If the LED lighting is applied using photovoltaic solar power technology, then the savings are considerably greater.

Wider Range of Working Voltage Options—LED lighting only require tiny amounts of power to operate efficiently, which is ideal when considering systems to be run from photovoltaic solar or wind generated power (e.g., 24 Vdc or 48 Vdc). There is also the option of running LED lighting systems from mains generated power (e.g., 110 Vac˜277 Vac 50 Hz˜60 Hz) via transformers at vastly reduced running costs.

Low Heat Output—Maximum LED operating temperatures are typically 60° C. rather than the 300°-450° C. operating temperatures of conventional lighting solutions. Heat pollution is therefore reduced offering savings of secondary interior systems, such as air conditioning.

Quality Of Light—The quality of the “white” light available can be tailored with LED lighting to suit the human eye—eliminating eye strain, which in certain working and living environments can have adverse and costly implications, together with health and safety issues. LEDs do not produce ultraviolet light and can be perfectly matched to a specific color rendering index (CRI) for industrial and regulatory standards requirements.

It is to be understood that the devices and subsystems of the illustrative embodiments are for illustrative purposes, as many variations of the illustrative hardware and/or devices used to implement the illustrative embodiments are possible, as will be appreciated by those skilled in the relevant art(s). In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or devices.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, cloud computing networks, a combination thereof, and the like.

It is to be understood that the described devices and subsystems are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Although the devices and subsystems of the illustrative embodiments are described with respect to illustrative configurations, the devices and subsystems of the illustrative embodiments can be used together and/or separately in any suitable combinations, as will be appreciated by those skilled in the relevant art(s).

While the present invention have been described in connection with a number of illustrative embodiments and implementations, the present invention is not so limited, but rather covers various modifications and equivalent arrangements, which fall within the purview of the appended claims.

What is claimed is:

1. A light emitting diode (LED) lighting system, the system comprising:
a multi-channel LED driver circuit having an electromagnetic interference (EMI) filter and rectification circuit, a power factor correction (PFC) circuit, a current and voltage isolation circuit, a voltage control circuit, and a current control circuit;
a wireless interface coupled between the EMI filter and rectification circuit and the PFC circuit;
a heat sink including an intercooling and ventilation chamber for air or water cooling disposed therein;
one or more screw mount LEDs electrically coupled to the LED driver circuit and thermally coupled to the heat sink; and
a lens housing having one or more lenses integrally formed therein and removably coupled to the heat sink or screw mount LEDs and with the lenses disposed over the LEDs.

2. The system of claim 1, further comprising a phase correction circuit coupled to an input of the LED driver circuit.

3. The system of claim 1, further comprising a mounting bracket having clasps connected to ends of the heat sink.

4. The system of claim 1, wherein a plurality of the LEDs are uniformly dispersed on the heatsink and optically aligned with a respective plurality of the lenses.

5. The system of claim 1, wherein a plurality of the LEDs are uniformly dispersed, in series and optically aligned with a single respective lens disposed along a length of the lens housing.

6. A light emitting diode (LED) lighting method, including one or more process steps corresponding to the system of claims 1 through 5.

7. A light emitting diode (LED) lighting device, including one or more devices corresponding to the system of claims 1 through 5.
